(19) United States
(12) Patent Application Publication
(10) Pub. No.: US 2014/0222786 A1
(43) Pub. Date: Aug. 7, 2014

(54) Web Navigation System with Persistent Search Results

(71) Applicant: Dealer Dot Com, Inc., Burlington, VT (US)

(72) Inventors: Danielle Giandomenico Job, Shelburne, VT (US); Ryan Dunn, Burlington, VT (US); Jonah Schulte, Burlington, VT (US)

(73) Assignee: Dealer Dot Com, Inc., Burlington, VT (US)

(21) Appl. No.: 14/171,386

(22) Filed: Feb. 3, 2014

Related U.S. Application Data
(60) Provisional application No. 61/760,053, filed on Feb. 2, 2013.

(51) Int. Cl. G06F 17/30

(52) U.S. Cl. CPC G06F 17/30867
USPC 707/722

(57) ABSTRACT

A method of providing search results to a user on a website includes providing search results that include a plurality of members. The method further includes selecting a first member of the plurality of members in which the selecting causes a web page of the first member to open. The plurality of members remains in view and available for selection on the web page of the first member.

### FIELD

This patent application generally relates to a programmable computer system for providing results of a search. More particularly, it relates to a system that maintains all search results available for viewing while viewing a web page showing one of the search results.

### BACKGROUND

A list of search results has typically been presented as a list on a web page, and a user may click on one member of the list to view the web page with that member. However, when viewing the web page of that member, the user has departed from the web page containing the list of all the search results. Similarly, the user has departed from the web page of that member to return to the list of search results when the user wished to view the web page of a second member of the list of search results. The present applicants recognized that a better scheme is needed, and such solutions are provided by the following description.

### SUMMARY

One aspect of the present patent application is a method of providing search results to a user on a website. The method includes providing search results that include a plurality of members. The method further includes selecting a first member of the plurality of members in which the selecting causes a web page of the first member to open. The plurality of members remains in view and available for selection on the web page of the first member.

Another aspect is a method of providing search results to a user on a website. The method includes providing search results on a web page that includes a plurality of members. The method also includes providing a user file. The method also includes providing a tab on the web page for saving a selected member of the plurality of members in the user file.

Another aspect is a method of providing search results to a user on a website. The method includes providing search results on a web page that includes a plurality of members. The method also includes selecting a first member, wherein said selecting causes a web page of said first member to open, wherein said plurality of members remains in view and available for selection while viewing said web page of said first member. The method also includes selecting a second member, wherein said selecting causes a web page of said second member to open, replacing said web page of said first member, wherein said plurality of members remains in view and available for selection while viewing said web page of said second member.

Another aspect is a method of providing search results to a user on a website. The method includes providing search results on a web page that includes a plurality of members. The method also includes selecting a member and viewing the web page for the member. The method also includes providing a navigation schematic that provides continued search capability when viewing the page for the selected member.

Another aspect is a method of providing search results to a user on a website. The method includes providing search results on a web page that includes a plurality of members. The method also includes selecting a first member in which the selecting causes a web page of the first member to open. The web page includes capability for at least one from the group consisting of user selection and user input. The plurality of members remains in view and available for selection while viewing the web page of the first member. The plurality of members remains in view and available for selection when the user provides at least one from the group consisting of user selection and user input on the web page of the first member.

### BRIEF DESCRIPTION OF THE DRAWINGS

The foregoing will be apparent from the following detailed description, as illustrated in the accompanying drawings, in which:

FIG. 1a is a screen shot of a web site illustrating a navigation schematic containing a list of search results visible on a web page that shows all the members of the list of search results;

FIG. 1b is a screen shots showing more detail of the navigation schematic of FIG. 1a on a web page of one of the members of the list;

FIG. 1c is a screen shots showing more detail of the navigation schematic of FIG. 1a with several members of a list of search results;

FIG. 1d is a screen shot showing a web page showing a list of the members of the search results with the navigation schematic hidden, and showing how to unhide the navigation schematic;

FIG. 1e is a screen shot showing more features of the navigation schematic on a web page of one of the members of the list of search results;

FIG. 1f is a screen shot showing more features of the navigation schematic on a home page of a dealership;

FIG. 1g is a screen shot showing a vehicle listing web page;

FIG. 1h is a screen shot showing a navigation schematic with search filters and a list of the results of the search;

FIG. 1i is a screen shot showing a navigation schematic with search filters hidden and showing a list of the results of the search and the result of clicking on the “request more info button”;

FIGS. 2a-2b are screen shots showing a navigation schematic and a drag and drop technique by which a user may select a member of the list of search results for saving in a user file;

FIGS. 3a-3b are screen shots showing an embodiment of a navigation schematic and a drag and drop technique by which a user may select a member of the list of search results and request more information about that member wherein, in this embodiment, requesting more information about a member of the list also includes saving the selected member of the list shown in FIGS. 2a-2b, and vice versa;

FIG. 4 is a screen shot showing a navigation schematic with search filters hidden and showing a list of the results of the search;

FIG. 5 is a screen shot showing the results of pressing a compare button to compare selected members of a list of the search results;

FIG. 6 is a flow chart showing steps in initializing to provide the navigation schematic of FIG. 1a;

FIG. 7 is a flow chart showing user operation to drag the navigation schematic to another location on a web page and the resulting operations performed by the web server to maintain the selected location;

FIGS. 8-9 are flow charts showing user operations to hide and unhide the navigation schematic of FIG. 1a and the resulting operations performed by the web server;

FIG. 10 is a flow chart showing user operation to search using the freeform search feature on the navigation schematic and the resulting operations performed by the web server;

FIG. 11 is a flow chart showing user operation to search using the facet search feature on the navigation schematic and the resulting operations performed by the web server;

FIG. 12 is a flow chart showing the configuration of the search button on the navigation schematic and the resulting operations performed by the web server when the user presses the search button to navigate to a full results page;

FIG. 13 is a flow chart showing the resulting operations performed by the web server when the user presses the “All Results” link;

FIG. 14 is a flow chart showing the user operations to view full details about one of the members found in the search and the resulting operations performed by the web server;

FIG. 15 is a flow chart showing the user operations to reset search and the resulting operations performed by the web server;

FIG. 16 is a flow chart showing the user operations to clear and the resulting operations to remove content in the request form on the navigation schematic performed by the web server;

FIGS. 17a-17b are flow charts showing the user operations to show and hide search form sections of the navigation schematic and the resulting operations performed by the web server;

FIG. 18 is a flow chart showing the user operations to expand the information request panel on the navigation schematic and insert information on the form that appears and the resulting operations performed by the web server;

FIG. 19 is a flow chart showing the user operation to navigate to another page of the web site without interacting with the navigation schematic and the resulting operations performed by the web server;

FIG. 20 is a flow chart showing the user operations to select members of the list of search results on the navigation schematic by dragging the members to the information and the resulting operations performed by the web server;

FIG. 21 is a flow chart showing the operations performed by the web server to maintain the navigation schematic in view on the page regardless of the user's scroll interactions with the page; and

FIG. 22 is a flow chart showing the user operations to adjust the height of the navigation schematic and the resulting operations performed by the web server to resize.

### DETAILED DESCRIPTION

The present applicants created a system that allows a user to do a search, see a listing of the results of that search, select a first member of those results and, while seeing the web page of that first member, also keep the listing of search results actively available and in sight on the web page of the first member and available for selecting another member. Thus, the user does not have to go back to the previous web page to view the list of search results in order to select a second member of the list. The user can click on the second member of the original search results and see the web page of that second member replacing the search results of the first member.

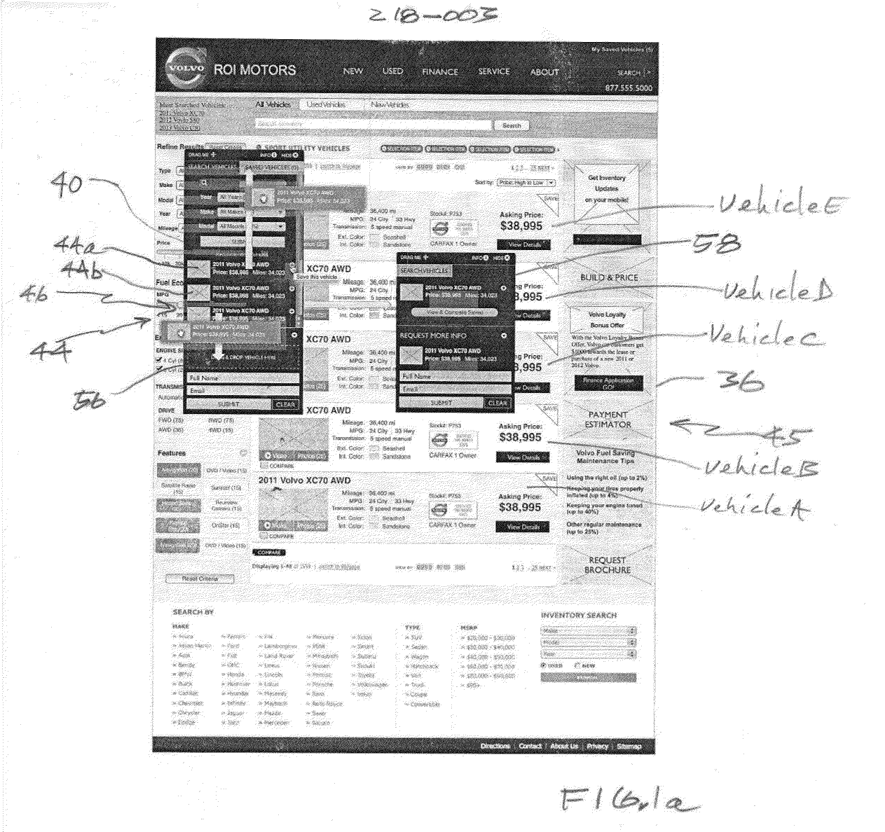

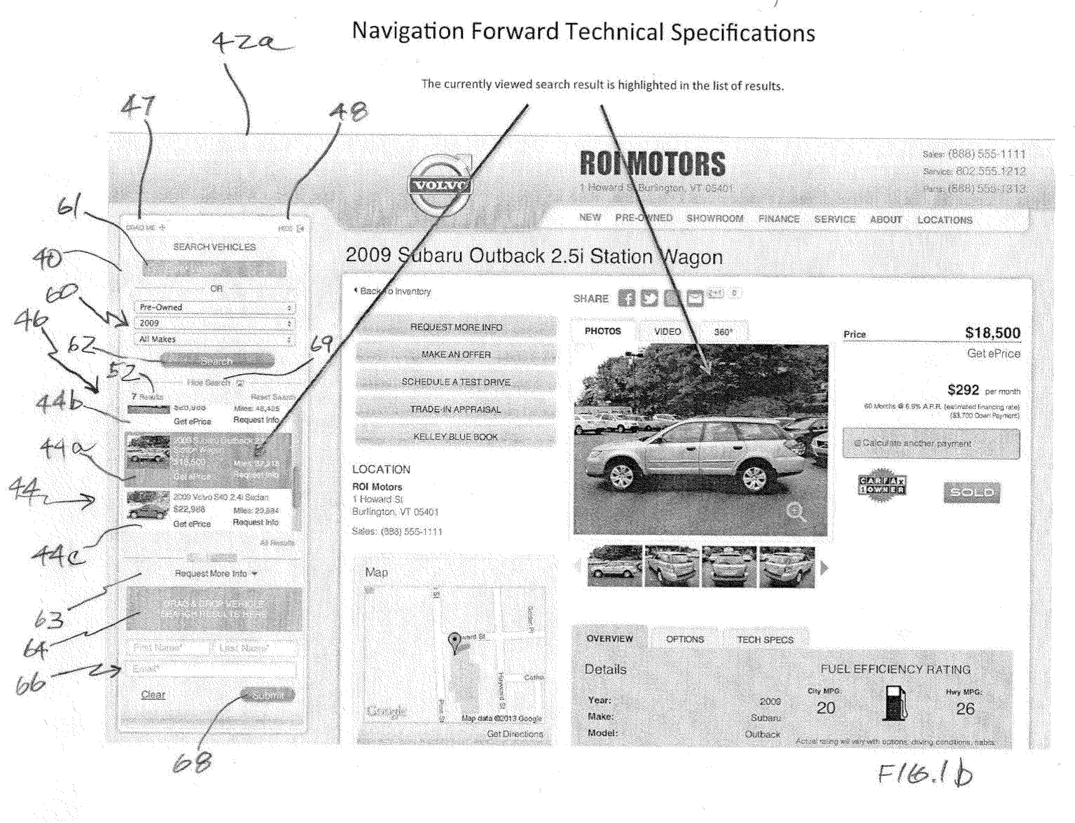

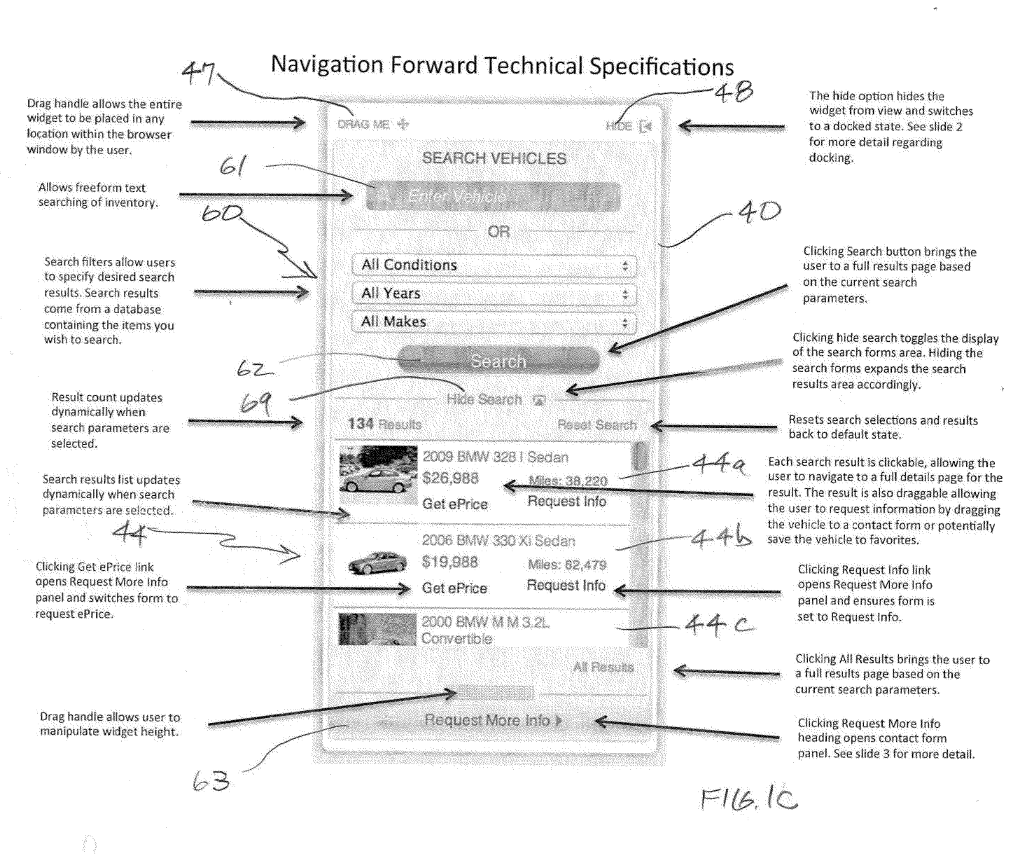

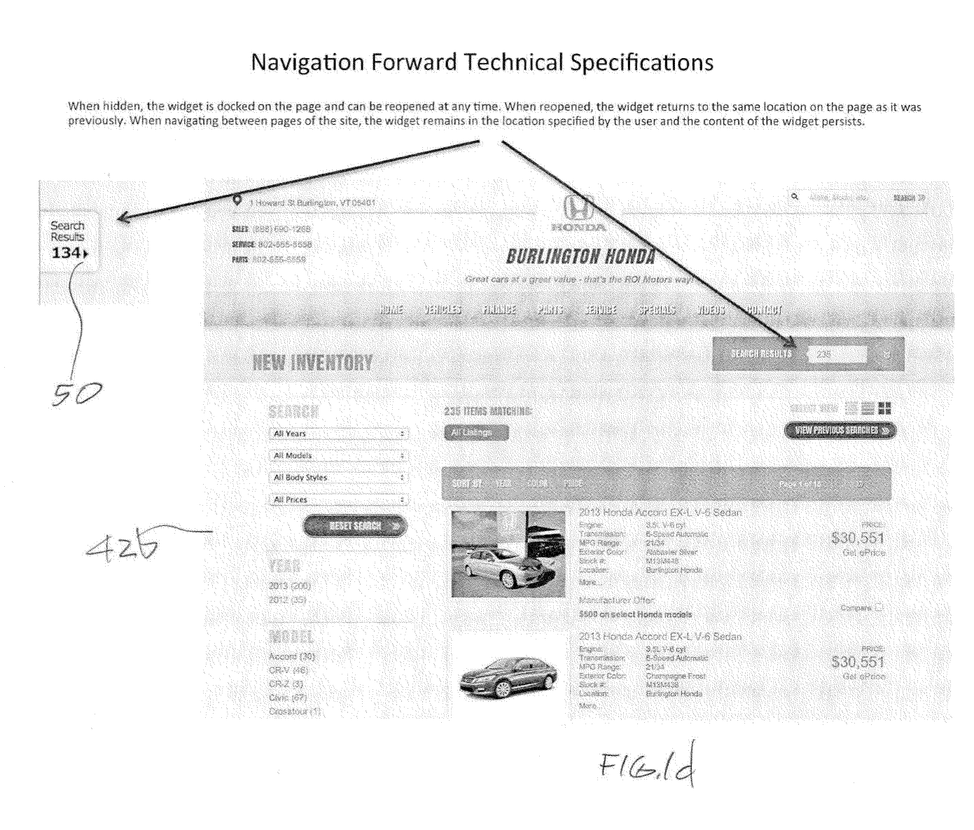

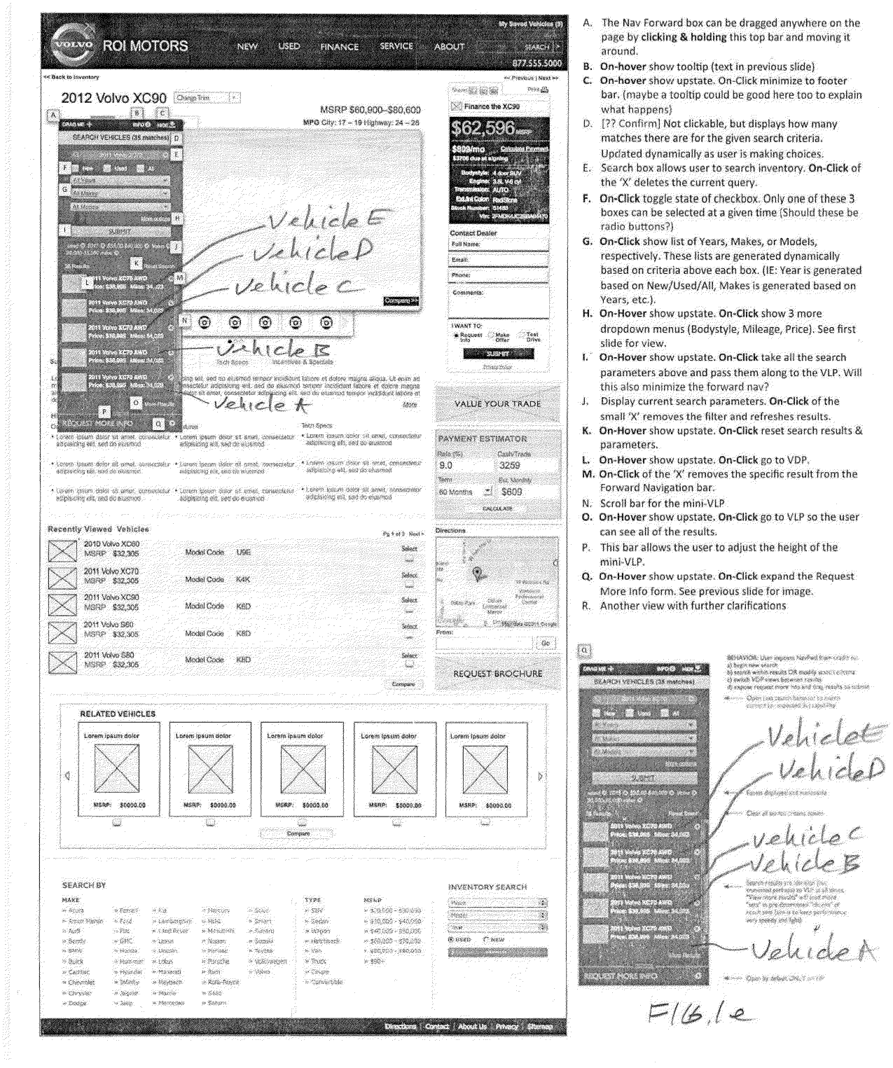

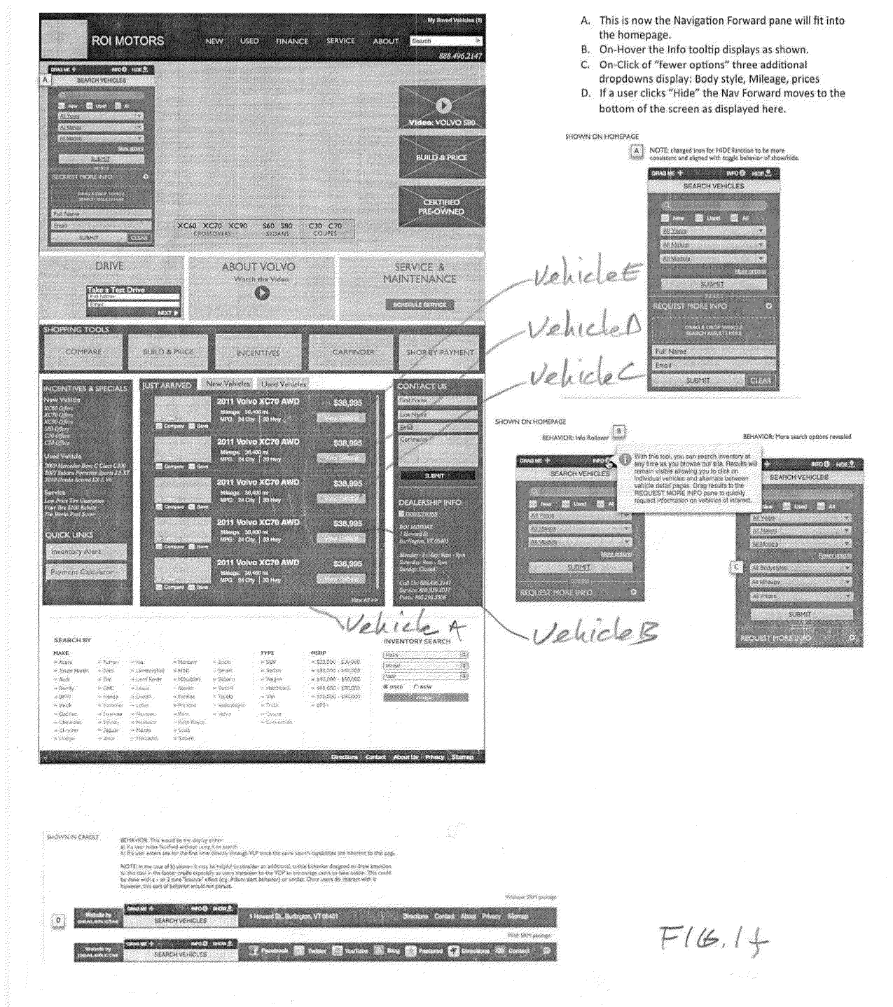

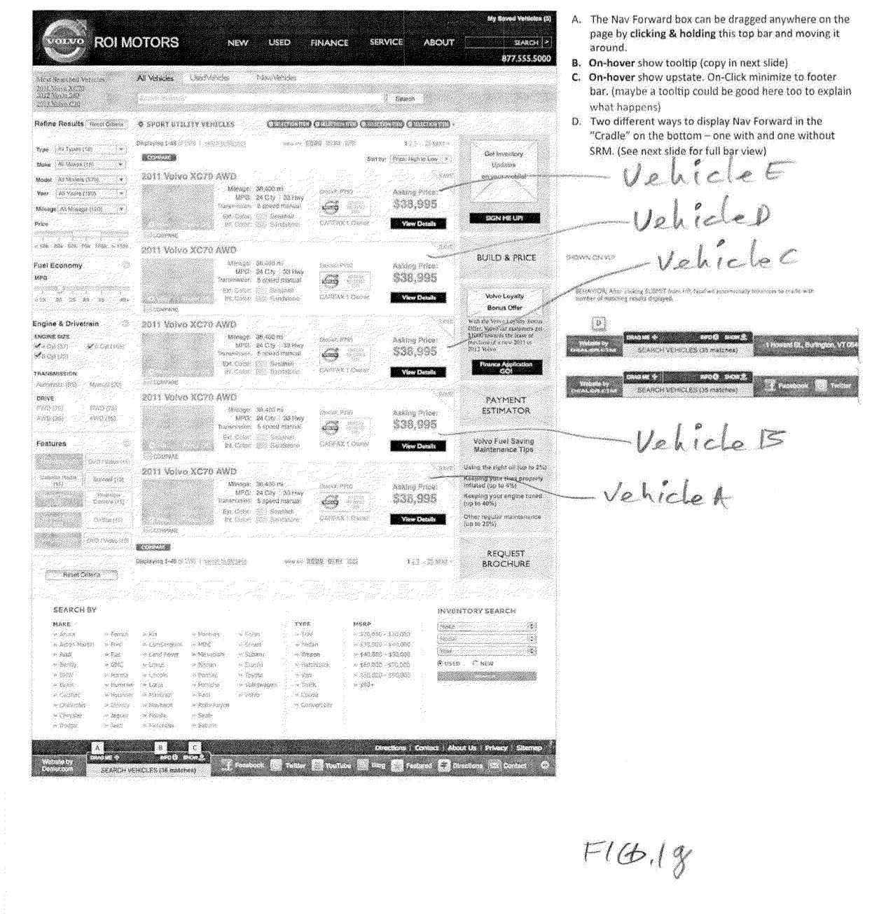

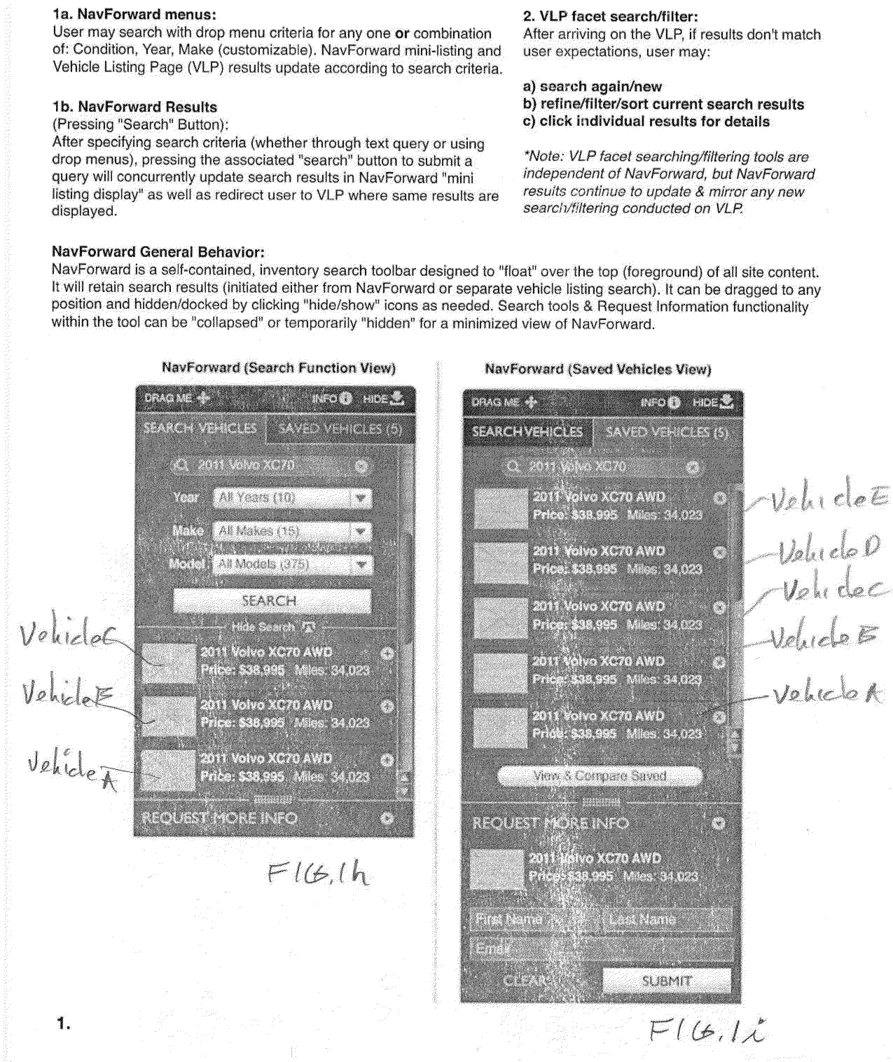

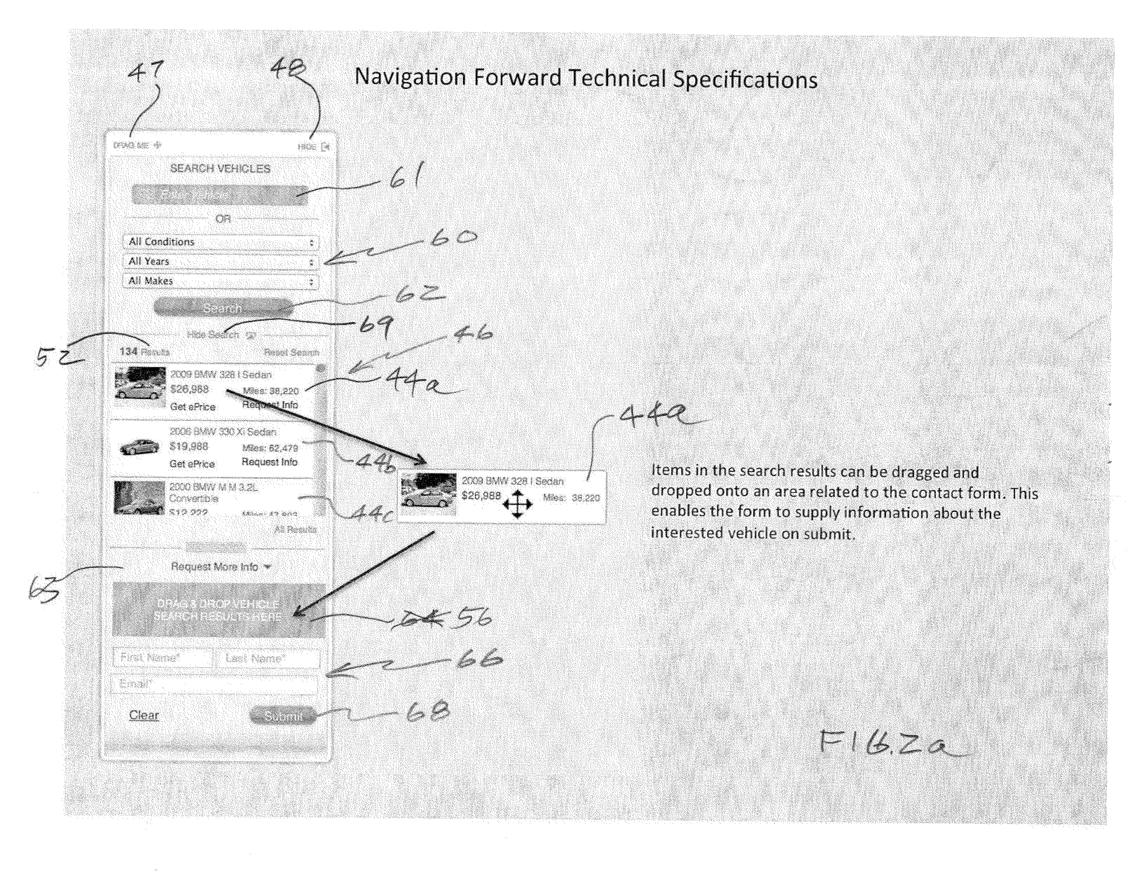

In one embodiment, a user may enter search criteria and receive search results, both on web page 36 and also in navigation schematic 40, as shown in FIG. 1a. The search results include vehicles identified as vehicles A, B, C, D, and E. More detail of navigation schematic is shown in FIG. 1b-1c. Navigation schematic 40 remains visible while web page 42a of first member 44a is selected and opened, as shown in FIG. 1b. Selection is accomplished by clicking on member 44a either as it is in listing 45 of search results on web page 36 or listing 46 within navigation schematic 40. Members 44 of listing 46 of search results within navigation schematic 40 remain available for viewing and selection in navigation schematic 40 while viewing web page 42a.

In one embodiment, navigation schematic 40 remains in view on web page 42a independent of the portion of web page 42a of first member 44a viewed by the user. Thus, as the user scrolls down web page 42a of first member 44a viewed, in this embodiment, navigation schematic 40 moves down web page 42a to remain in view in the same location with respect to the viewing area. The user can therefore click on another member 44b of listing 46 of search results at any time to see that other member's web page. Since first member 44a remains in list 46 in navigation schematic 40, the user can click to toggle back from web page 44b to see its web page 44a again. The user can also move navigation schematic 40 to other locations in the viewing area by clicking on drag me button 47 and dragging navigation schematic 40.

Navigation schematic 40 includes hide button 48, as shown in the upper right hand corner of navigation schematic 40. When navigation schematic 40 is hidden, the user may reveal navigation schematic 40 by clicking on unhide button 50 on web page 42b, as shown in FIG. 1d. Additional features are shown in FIG. 1e-1f, including info, hovering with the mouse to provide tooltips, and check boxes for new, used, and all vehicles. The vehicle listing page (VLP) is shown in FIG. 1g. The use of a single or a combination of search filters in floating navigation schematic 40 is illustrated in FIG. 1h. The results of clicking hide search and also clicking the request more information button is shown in FIG. 1i.

The number of search results 52 is automatically indicated on navigation schematic 40.

In one embodiment, navigation schematic 40 is integrated in the web page viewed, such as web page 36 or web page 42a. While the user is looking at navigation schematic 40 integrated in web page 42a of member 44a the user may choose to select second member 44b. The web page of second member 44b then replaces the web page of first member 44a. Navigation schematic 40 remains in view, now integrated in web page 42b.

Alternatively, navigation schematic 40 can be in a separate web page or a pop up window from web pages 42a, 42b but still provide functionality as described herein. In this embodiment, a user can arrange to see both web pages at once on one or more screens. In this embodiment, navigation schematic 40 can have functionality including search and search results plus one or more other functions, such as ability to save one or more members of the search results, user request for more information about one or more members of the search results, and provision for user input, such as user identifying and/or contact information.

Selecting a first member 44a causes a web page 42a of the first member to open. In one embodiment, web page 42a includes capability for user selection and/or user input. List of members 44 remains in view and available for selection of second member 44b while viewing web page 42a of the first member. List of members 44 continues to remain in view and available for selection when the user makes a selection and/or provides user input on web page 42a of first member 44a.

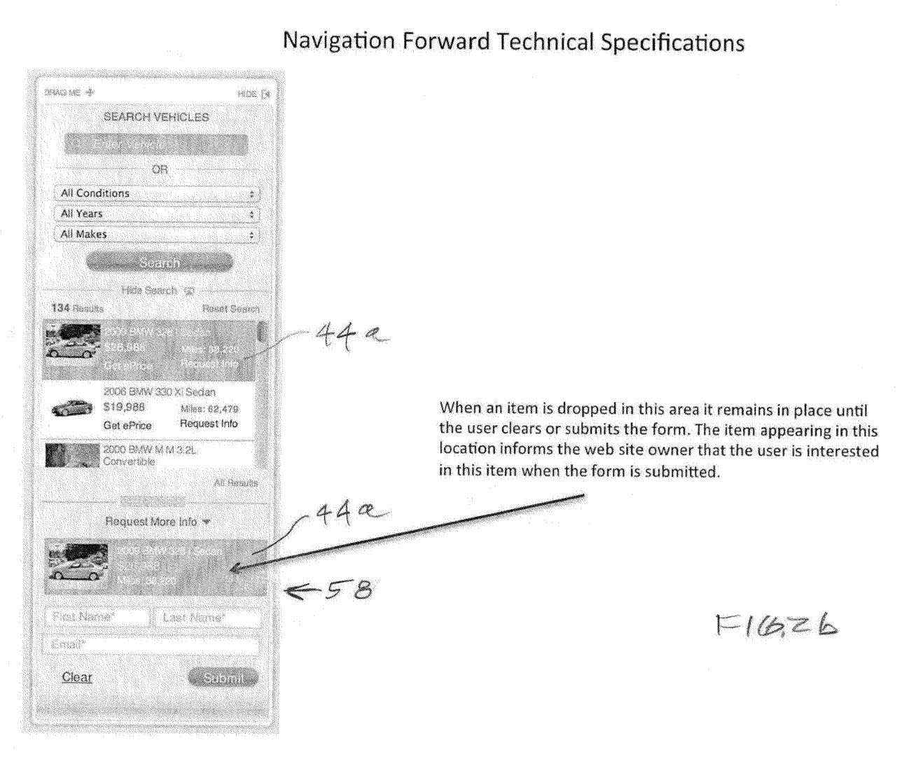

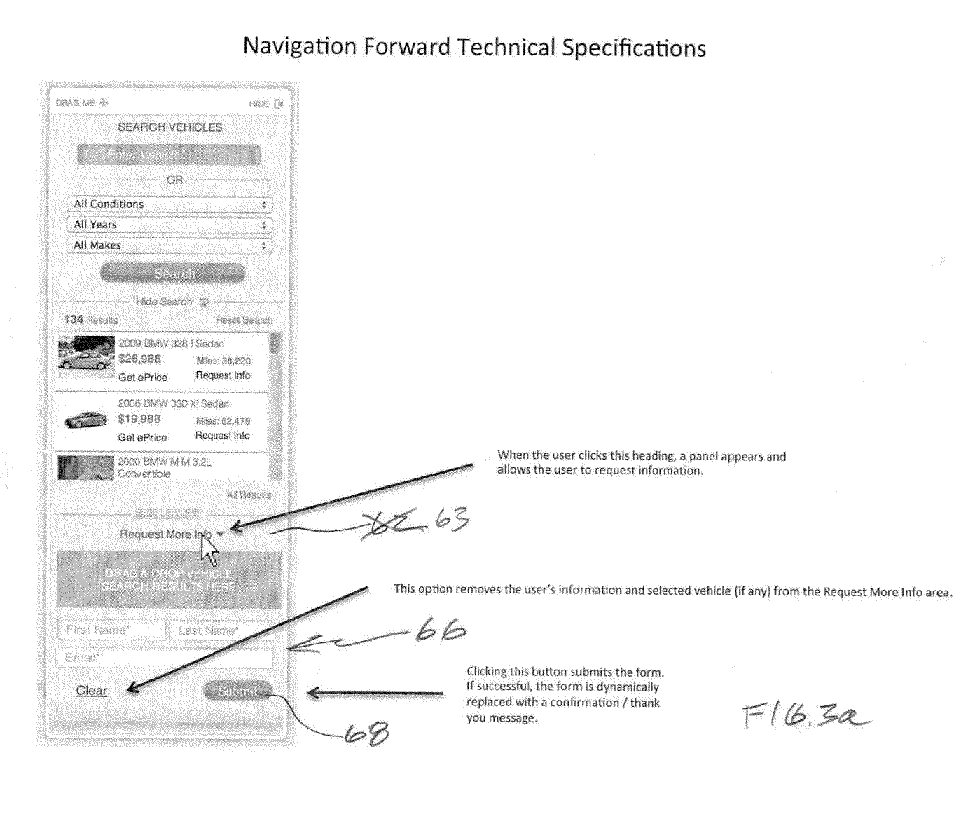

Navigation schematic 40 may include associated user file tab 56 into which the user can drag and drop its member 44a from list 46 for saving in an associated user file, as shown in FIGS. 2a, 2b. Additional members 44b, 44c . . . can be selected for viewing, as described herein above, and one of more of these additional members 44b, 44c . . . can also be saved in the user file by dragging and dropping their members 44b, 44c in list 46 into user file tab 56. The user can view the saved members which are shown listed in navigation schematic 40 tab 58.

In one embodiment, navigation schematic 40 includes facet search 60, search filter tabs that allow the user to adjust what is searched for and to obtain a new search results listing, as shown in FIGS. 1a, 1b. For example, a search for cars can include criteria for year, make, and model, as shown in facet search 60 of navigation schematic 40. Other facet search filters can be included, such as body style, mileage, and price. In one embodiment navigation schematic 40 provides the user with the ability to further refine search or filtering when the user is viewing the page for a selected member. User defined search criteria can also be included, as shown in the “enter vehicle” tab 61. Thus, a user can search for all cars of a particular color, for example. Entering such a free form search and pressing enter button 62 disables other search options and updates the search results with the user defined search.

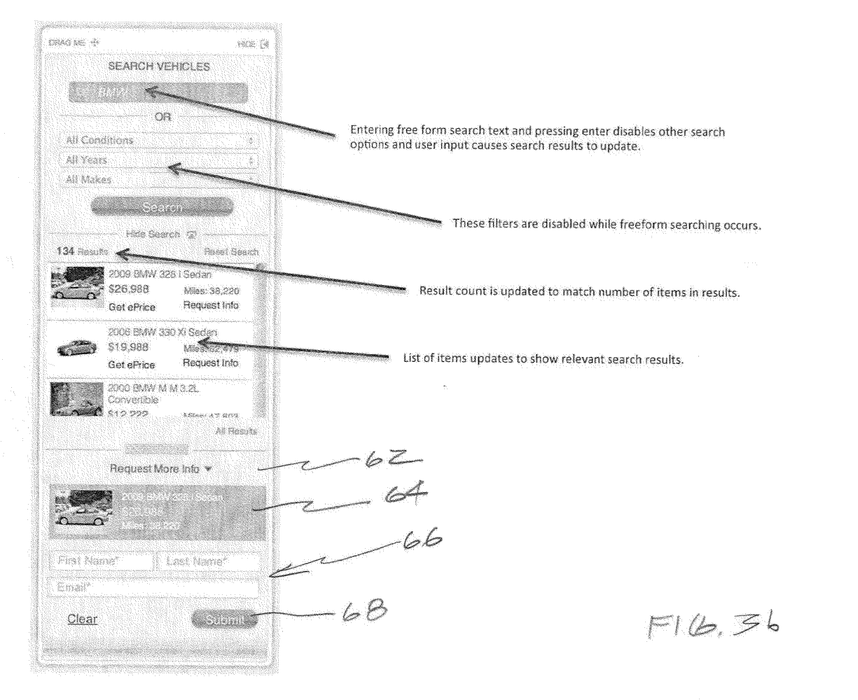

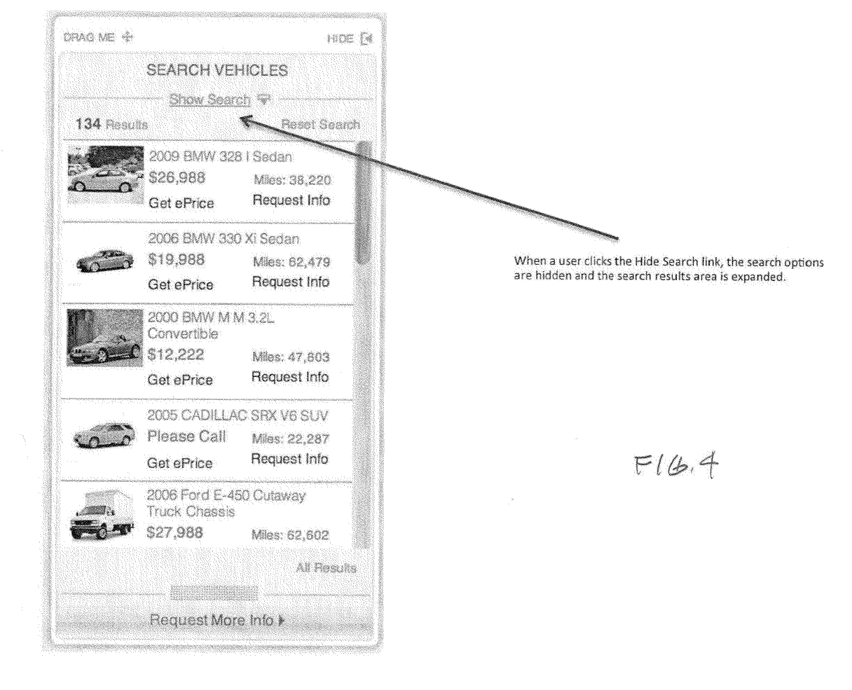

In one embodiment, web page 42a may include a “request further information” button and/or a user input button, as shown in FIGS. 1a, 1b, and 3a, 3b. In one embodiment, navigation schematic 40 includes request further information button 63. When request further information button 63 is clicked, additional tabs open, including tab 64 for the user to indicate which member of list 44 the user wants more information about, tabs 66 for the user to enter user information, such as name and email address, and submit button 68 for submitting the request. Navigation schematic 40 can also include a user input button (not shown) that allows the user to enter any additional information about the member or about the user or a question or a special request. A request for further information can include a request for a price, an appointment, product details, availability, and/or delivery information. The user input can include an offer to purchase and/or a comment. Members 44 of list 46 remain available for viewing and selection in navigation schematic 40 while web page 42a of first member 44a is open and these and other tasks are being performed by the user.

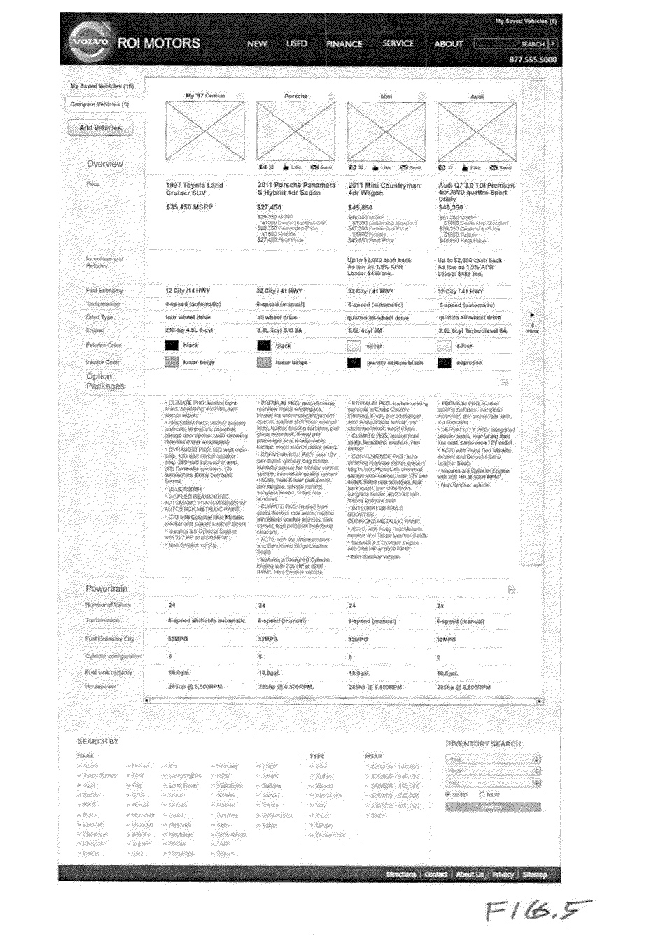

Once the user has search results, the user can use hide search button 69 to remove facet search 60 and “enter vehicle” tab 61, providing more room to see search results, as shown in FIG. 4.

In one embodiment, website 42 is supervised by an entity, such as Dealer Dot Com, Inc. When the user submits a request for further information and/or provides user input, the entity receives that request or user input.

In one embodiment, a compare button is provided (not shown), for comparing more than one of the members 44 of the search results that have been saved. Selecting the compare button for the selected members provides a comparison of the selected members, as shown in FIG. 5. In this embodiment, an associated user file is provided and those members that the user previously saved in the user file are the ones compared.

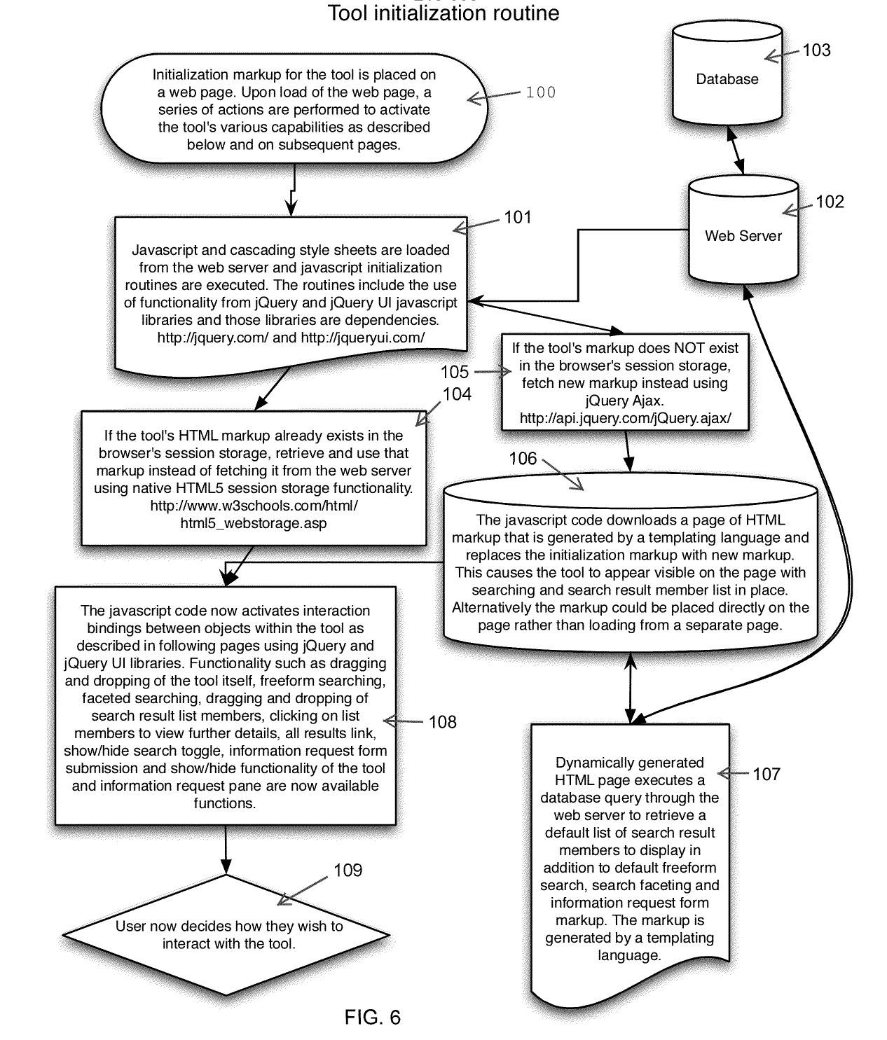

In operation, initialization for navigation schematic 40 is placed on a web page, as shown in tab 100 of FIG. 6. Upon loading of the web page, a series of actions are performed to activate the navigation schematic's various capabilities, as described herein and in subsequent figures.

Javascript and cascading style sheets are loaded, as shown in box 101 from the web server and data base shown in boxes 102 and 103, and javascript initialization routines are executed. The routines include the use of functionality from jQuery and jQuery UI javascript libraries and those libraries are dependencies. These libraries are available for free download from http://jquery.com/ and from http://jqueryui.com/. These sites, and all the citations cited herein below are incorporated herein by reference.

If the navigation schematic's HTML markup already exists in the browser's session storage, the processor retrieves and uses that markup instead of fetching it from the web server using native HTML5 session storage functionality, as shown in box 104 and as further described at http://www.w3schools.com/html/html5_webstorage.asp.

If the navigation schematic's markup does NOT exist in the browser's session storage, fetch new markup instead using jQuery Ajax, as shown in box 105 and further described at http://api.jquery.com/jQuery.ajax/. In that case the javascript code downloads a page of HTML markup, as shown in box 106 that is generated by a templating language, as shown in box 107, and replaces the initialization markup with new markup using jQuery replaceWith, as further described at http://api.jquery.com/replaceWith/. This causes navigation schematic 40 to appear visible on the page with searching and search result member list in place. Alternatively the markup could be placed directly on the page rather than loading from a separate page.

The dynamically generated HTML page of box 107 executes a database query through the web server to retrieve a default list of search result members to display in addition to default freeform search, search faceting and information request form markup. The markup is generated by a templating language.

In either case, the javascript code now activates interaction bindings between objects within navigation schematic 40 as described in following pages using jQuery and jQuery UI libraries, as shown in box 108. Functionality such as dragging and dropping of navigation schematic 40 itself, freeform searching, faceted searching, dragging and dropping of search result list members, clicking on list members to view further details, all results link, show/hide search toggle, information request form submission and show/hide functionality of navigation schematic 40 and information request pane are now available functions.

Now fully initialized for the variety of functions, as described herein below, the user now decides how they wish to interact with navigation schematic 40, as shown in box 109.

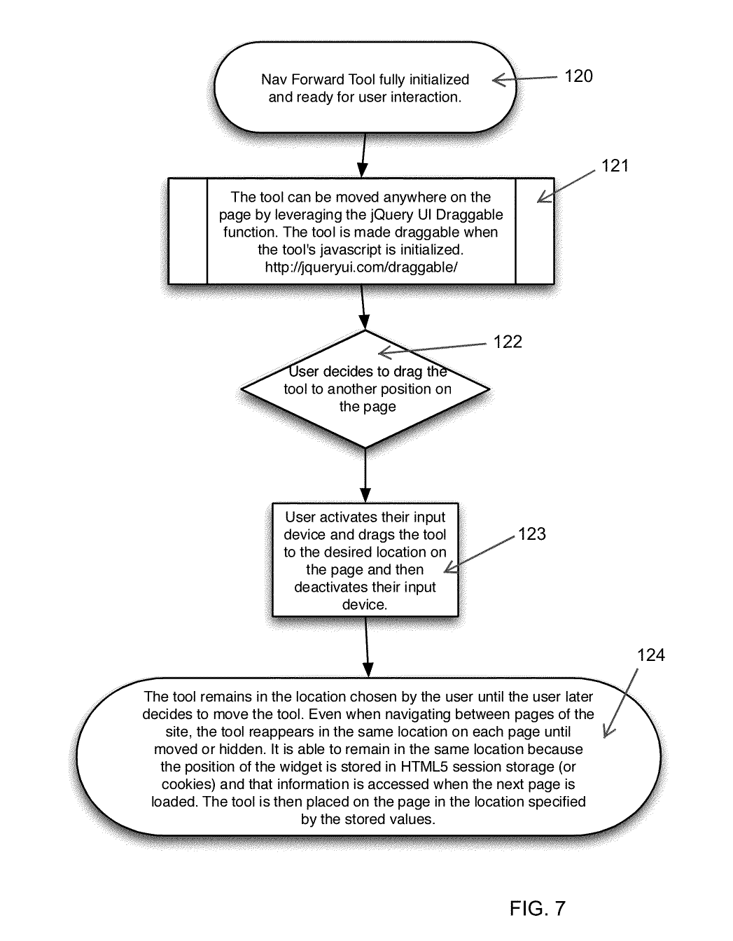

The fully initialized tool of box 120 of FIG. 7 can be moved anywhere on the page by leveraging the jQuery UI Draggable function, as shown in box 121. Navigation schematic 40 is made draggable when the navigation schematic's javascript is initialized, as further described at http://jqueryui.com/draggable/.

In one embodiment, the user decides to drag navigation schematic 40 to another position on the page, as shown in box 122. To accomplish this the user activates their input device, such as a mouse, and drags navigation schematic 40 to the desired location on the page and then deactivates their input device.

Navigation schematic 40 remains in the location chosen by the user until the user later decides to move navigation schematic 40. Even when navigating between pages of the site, navigation schematic 40 reappears in the same location on each page until moved or hidden. It is able to remain in the same location because the position of the widget is stored in HTML5 session storage (or cookies) and that information is accessed when the next page is loaded. Navigation schematic 40 is then placed on the page in the location specified by the stored values.

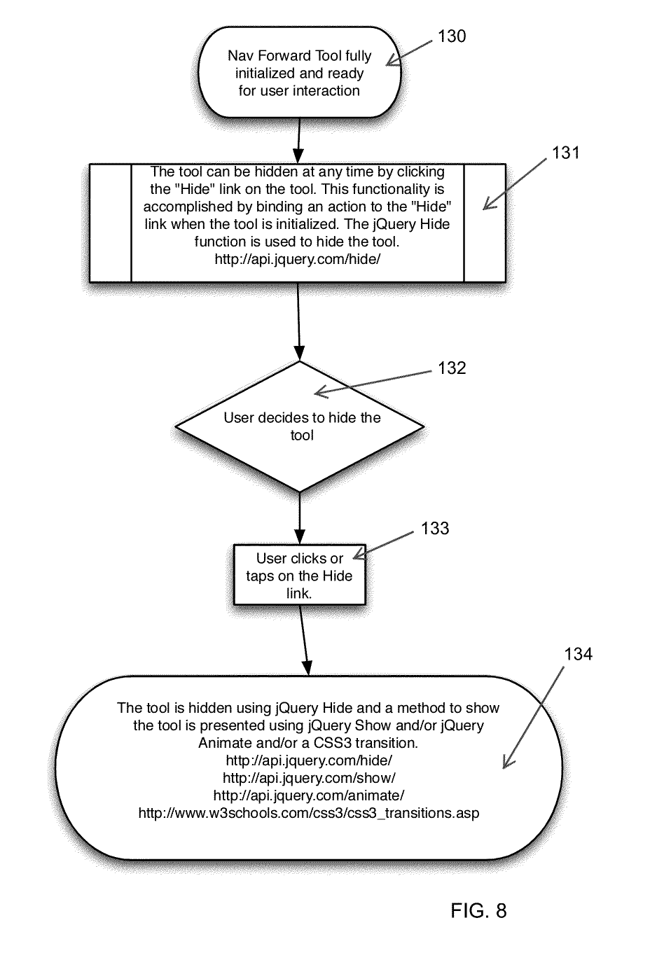

The fully initialized tool of box 130 of FIG. 8 can be hidden at any time by clicking the “Hide” link on the tool, as shown in box 131. This functionality is accomplished by binding an action to the “Hide” link when the tool is initialized. The jQuery Hide function is used to hide the tool, as more fully described at http://api.jquery.com/hide/.

If the user decides to hide the tool, as shown in box 132, the user clicks or taps on the Hide link, as shown in box 133. The tool is hidden using jQuery Hide, as shown in box 134. A method to show the tool again is presented using jQuery Show and/or jQuery Animate and/or a CSS3 transition, as further described in http://api.jquery.com/hide/, at http://api.jquery.com/show/, at http://api.jquery.com/animate/, and at http://www.w3schools.com/css3/css3_transitions.asp.

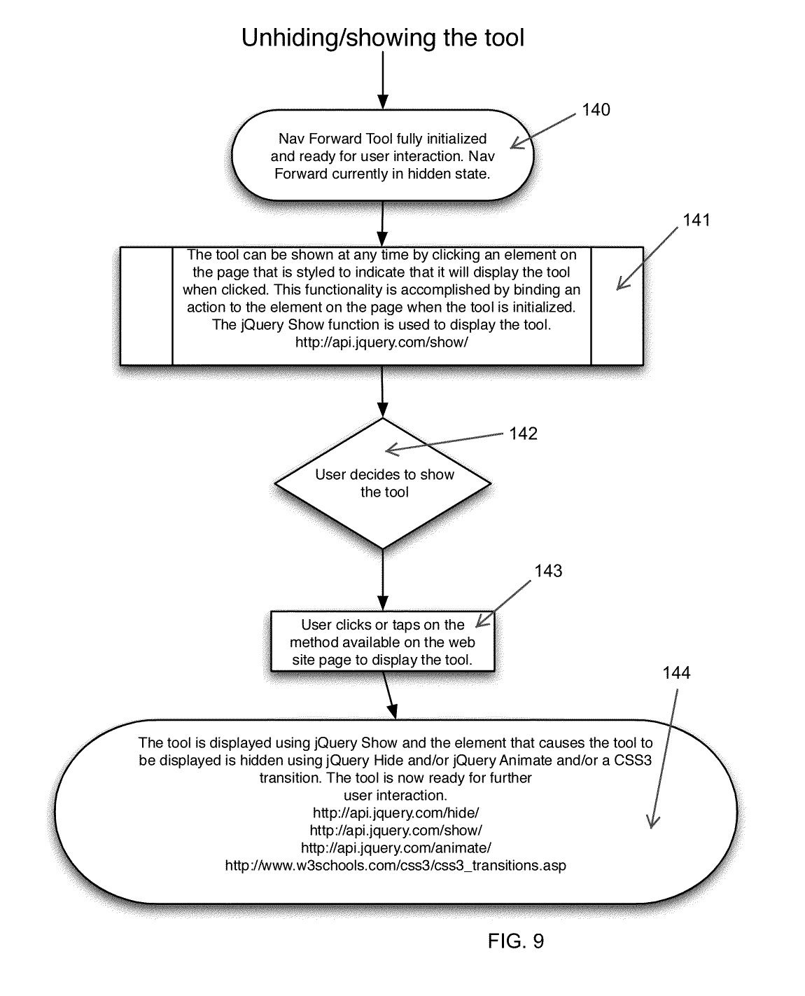

The fully initialized tool of box 140 of FIG. 9 can be shown at any time by clicking element 50 on the web page that is styled to indicate that it will display the tool when clicked, as shown in box 141. This functionality is accomplished by binding an action to the element on the page when the tool is initialized. The jQuery Show function is used to display the tool as further described in hap://api.jquery.com/show/

If the user decides to show the tool, as shown in box 142, the user clicks or taps on element 50 on the web page, as shown in box 143. The tool is displayed using jQuery Show, as shown in box 144. Element 50 that causes the tool to be displayed is hidden using jQuery Hide and/or jQuery Animate and/or a CSS3 transition. The tool is now ready for further user interaction. Additional information on this jquery function is available at http://api.jquery.com/hide/, http://api.jquery.com/show/, http://api.jquery.com/animate/, and http://www.w3schools.com/css3/css3_transitions.asp.

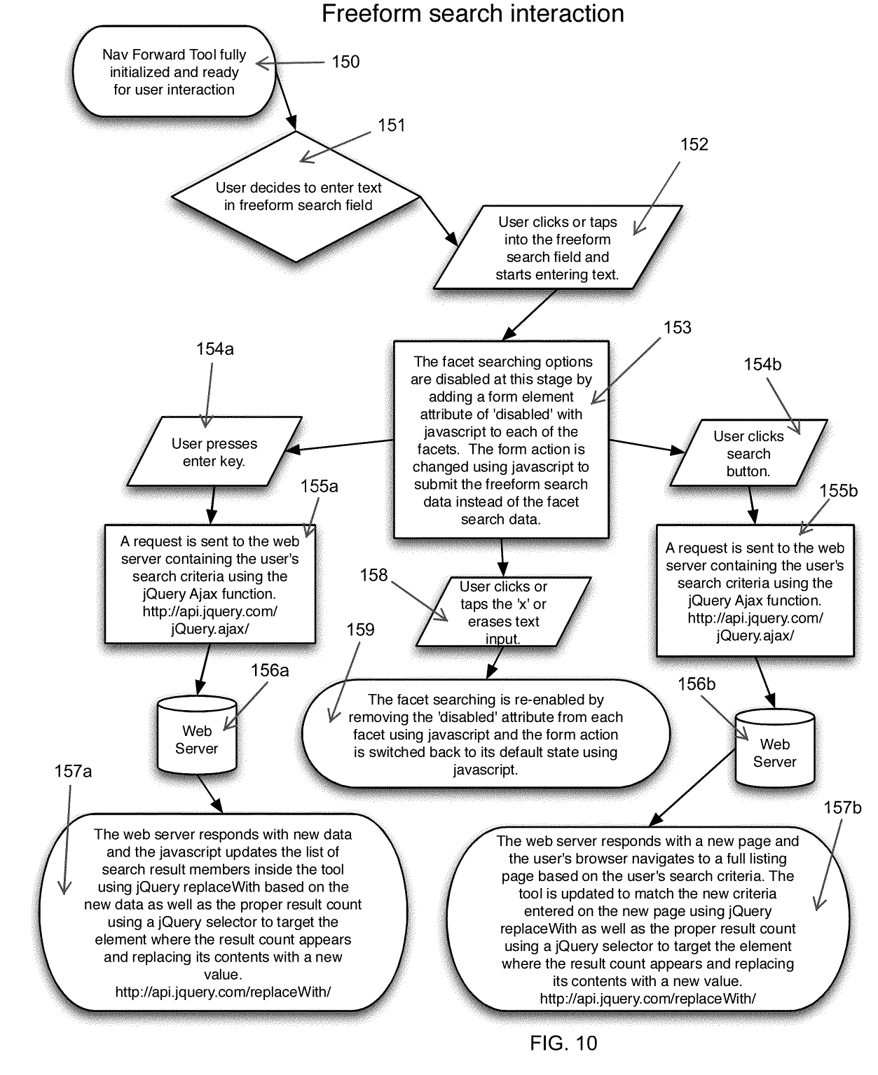

With the fully initialized tool of box 150 of FIG. 10, the user can decide to enter text in a freeform search field, as shown in box 151. The user clicks or taps into the freeform search field and starts entering text, as shown in box 152. Facet search 60 is disabled at this stage by adding a form element attribute of ‘disabled’ with javascript to each of the search filters or facets, as shown in box 153. The form action is changed using javascript to submit the freeform search data instead of the search filter or facet search data.

If the user presses the enter key, as shown in box 154a or clicks search button 62, as shown in box 154b, a request is sent to the web server containing the user's search criteria using the jQuery Ajax function, as shown in boxes 155a, 155b. This function is further described at http://api.jquery.com/ and at jQuery.ajax. The web server receives the request as shown in boxes 156a, 156b.

If the user pressed the enter key, the web server responds with new data, as shown in box 157a, and the javascript updates the list of search result members inside the tool using jQuery replaceWith based on the new data as well as the proper result count using a jQuery selector to target the element where the result count appears and replacing its contents with a new value. Further information about this is available at http://api.jquery.com/replaceWith/.

If the user clicked the search button, the web server responds with a new page, as shown in box 157b, and the user's browser navigates to a full listing page based on the user's search criteria. The tool is updated to match the new criteria entered on the new page using jQuery replaceWith as well as the proper result count using a jQuery selector to target the element where the result count appears and replacing its contents with a new value. Further information about this is available at http://api.jquery.com/replaceWith/.

If the user clicks or taps the ‘x,’ or erases the text input into search field 61, as shown in box 158, facet search 60 is re-enabled by removing the ‘disabled’ attribute from each facet search 60 using javascript and the form action is switched back to its default state using javascript, as shown in box 159.

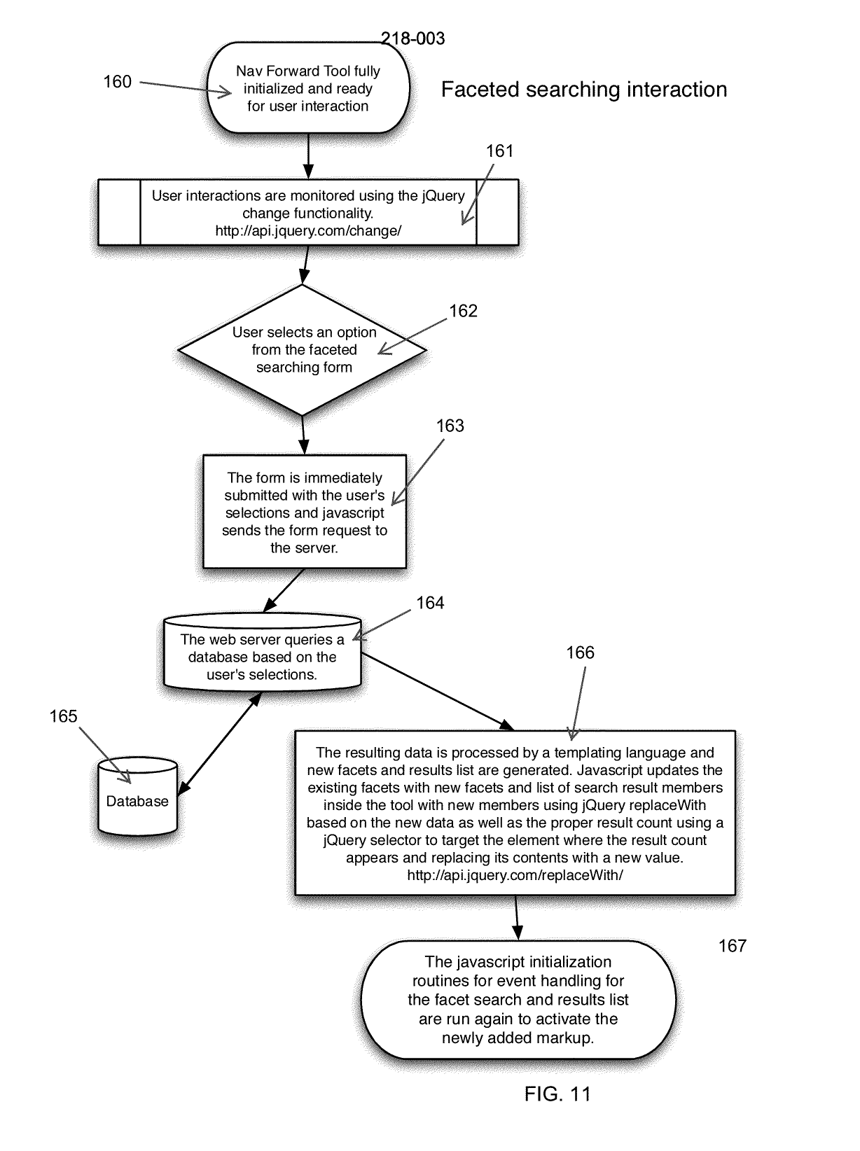

With the fully initialized tool of box 160 of FIG. 11, the user interactions are monitored using the jquery change functionality, as shown in box 161. More information is available at http://api.jquery.com/change/. If the user selects an option from search field 61 or the faceted searching form, as shown in box 162, the form is immediately submitted with the user's selections and javascript sends the form request to the server, as shown in box 163. The web server queries a database based on the user's selections, as shown in box 164.

The resulting data from database 165 is processed by a templating language, as shown in box 166, and new search fields 61 or facets and a results list are generated. Javascript updates the existing search fields 61 or facets with new search fields 61 or facets and list of search result members is provided inside the tool with new members using jQuery replaceWith based on the new data. The proper result count is added using a jQuery selector to target navfwd-results element 52 where the result count appears and replaces its contents with a new value based on the number of members found in the new search. Further information about this is available at http://api.jquery.com/replaceWith/. The javascript initialization routines for event handling for the facet search and results list are run again to activate the newly added markup, as shown in box 167.

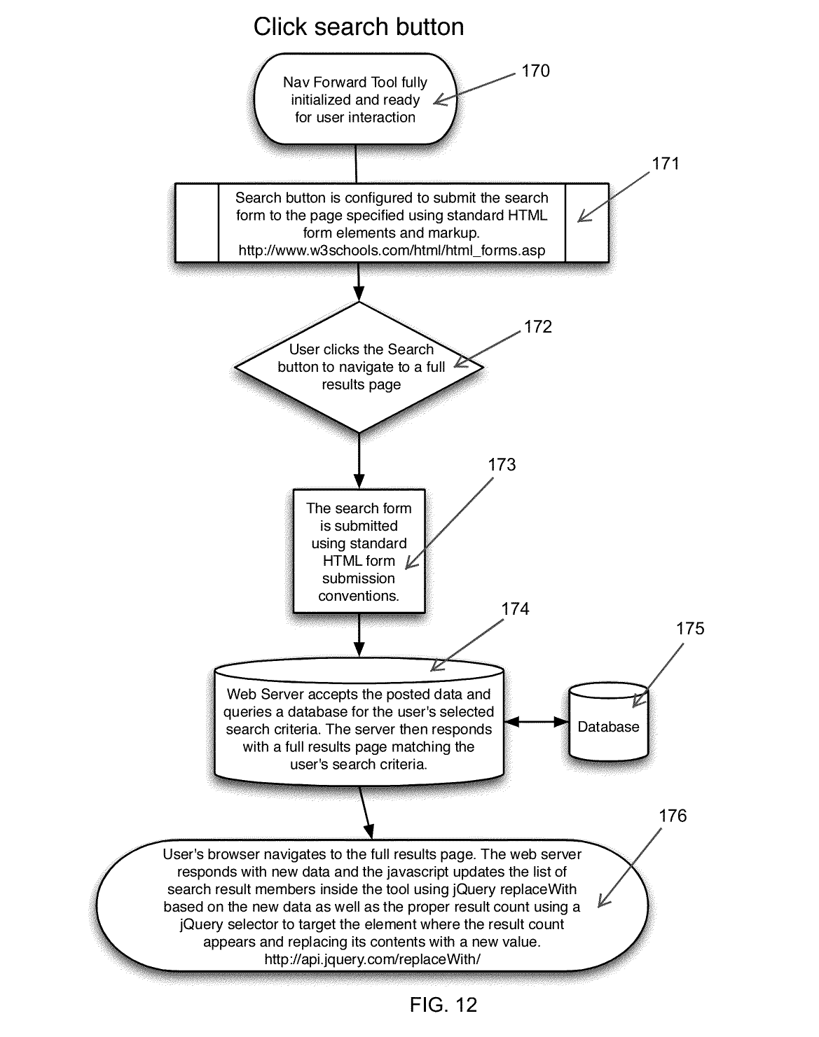

With the fully initialized tool of box 170 of FIG. 12, search button 62, named submit-search, is configured to submit the search form to the page specified using standard HTML form elements and markup, as shown in box 171. Additional information is available at http://www.w3schools.com/html/html_forms.asp.

If the user clicks the Search button to navigate to a full results page, as shown in box 172, the search form is submitted using standard HTML form submission conventions, as shown in box 173. The Web Server accepts the posted data, as shown in box 174, and queries a database for the user's selected search criteria, as shown in box 175. The server then responds with a full results page matching the user's search criteria. The user's browser navigates to the full results page, as shown in box 176. The web server responds with new data and the javascript updates the list of search result members inside the tool using jQuery replaceWith based on the new data as well as the proper result count using a jQuery selector to target the element where the result count appears and replacing its contents with a new value. Further information about this is available at http://api.jquery.com/replaceWith/.

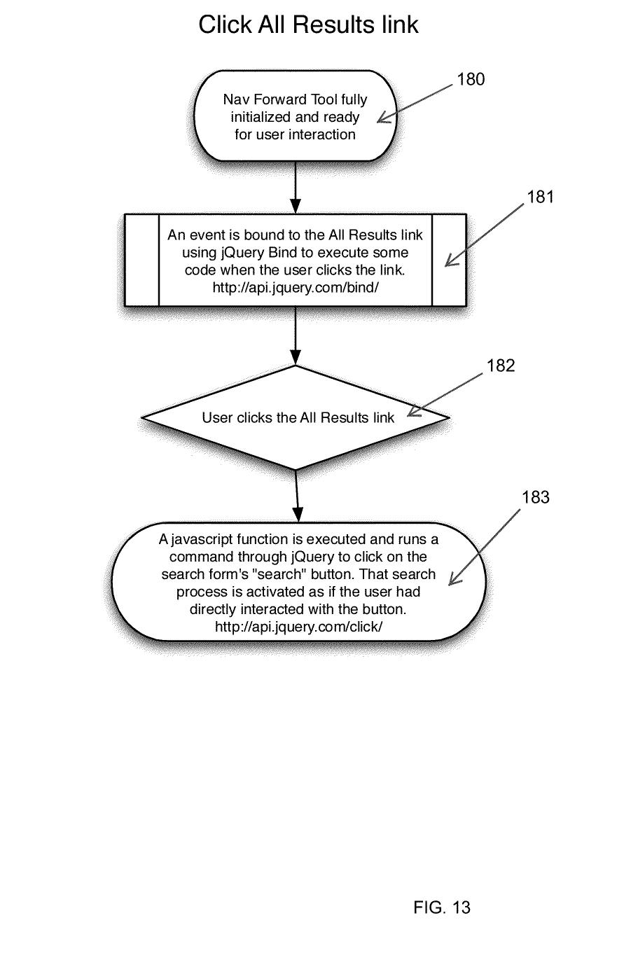

With the fully initialized tool of box 180 of FIG. 13, an event is bound to the All Results link using jQuery Bind to execute javascript code that uses jQuery Click to click on the Search button for the user when the user clicks the All Results link. Further information is available at http://api.jquery.com/bind/. If the user clicks the All Results link, as shown in box 182, a javascript function is executed and runs a command through jQuery to click on the search form's “search” button. That search process is activated as if the user had directly interacted with the button, as shown in box 183. Further information is available at http://api.jquery.com/click/.

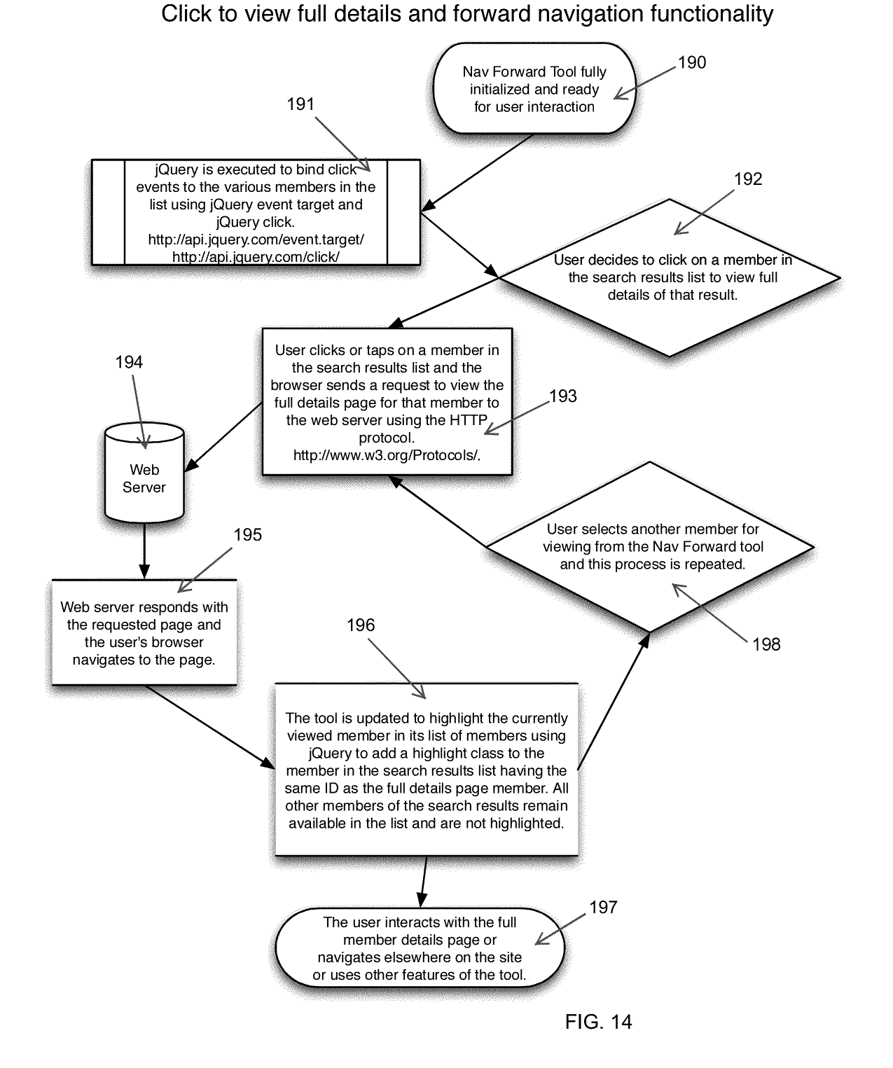

With the fully initialized tool of box 190 of FIG. 14, jQuery is executed to bind click events to the various members in the list using jQuery event target and jQuery click, as shown in box 191. Further information is available at http://api.jquery.com/event.target/ and http://api.jquery.com/click/. If the user decides to click on a member in the search results list to view full details of that result, as shown in box 192, the user clicks or taps on a member in the search results list, as shown in box 193, and the browser sends a request to view the full details page for that member to the web server, as shown in box 194, using the HTTP protocol. Further information is available at http://w3.org/Protocols/. The Web server responds with the requested page and the user's browser navigates to the page, as shown in box 195. The tool is updated to highlight the currently viewed member in its list of members using jQuery to add a highlight class to the member in the search results list having the same ID as the full details page member, as shown in box 196. All other members of the search results remain available in the list and are not highlighted. The user interacts with the full member details page or navigates elsewhere on the site or uses other features of the tool, as shown in box 197. Alternatively, the user selects another member for viewing from the Nav Forward tool and this process is repeated, as shown in box 198.

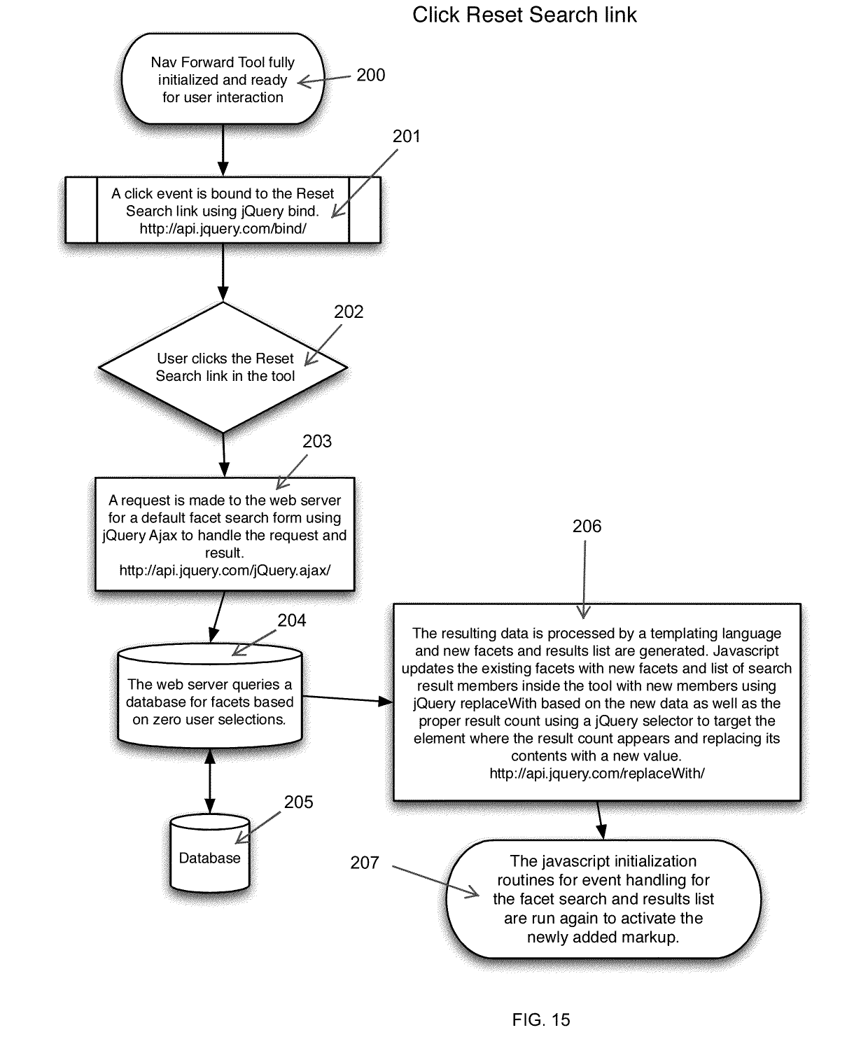

With the fully initialized tool of box 200 of FIG. 15, a click event is bound to the Reset Search link using jQuery bind, as shown in box 201. Further information is available at http://api.jquery.com/bind. If the user clicks the Reset Search link in the tool as shown in box 202, a request is made to the web server for a default facet search form using jQuery Ajax to handle the request and result, as shown in box 203 as further described in http://api.jquery.com/jQuery.ajax/. The web server queries a database for facets based on zero user selections as shown in box 204. Resulting data from the database, shown in box 205, is processed by a templating language and new facets and a results list are generated, as shown in box 206. Further information about this is available at http://api.jquery.com/replaceWith/. The javascript initialization routines for event handling for the facet search and results list are run again to activate the newly added markup, as shown in box 207.

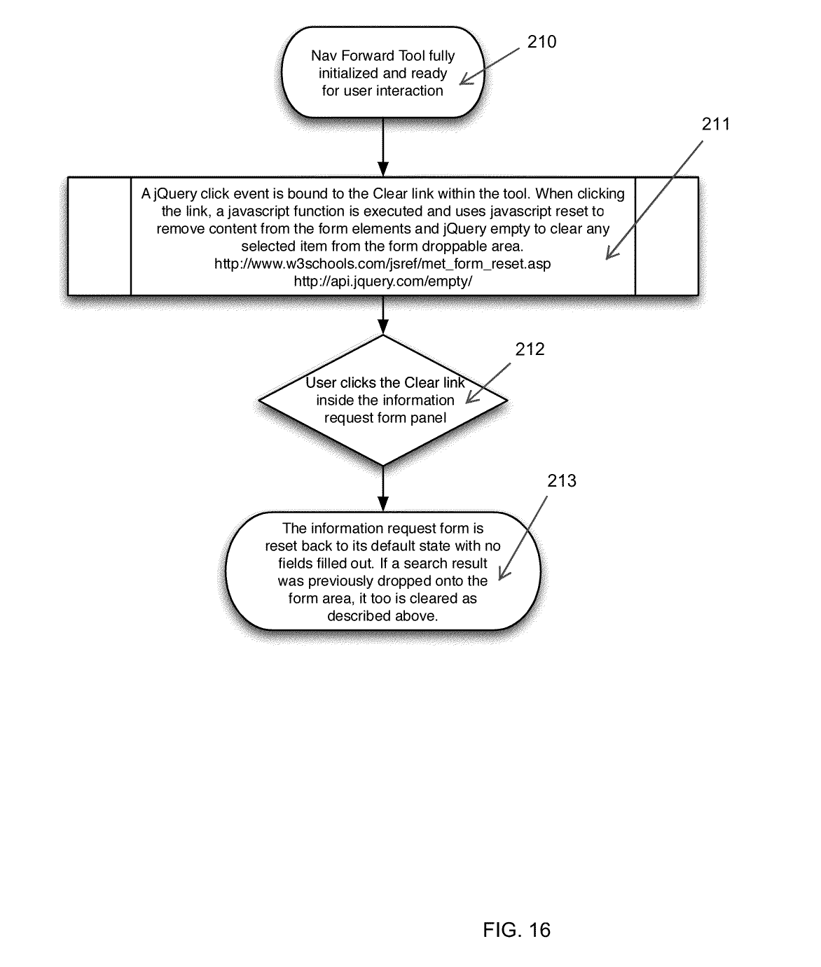

With the fully initialized tool of box 210 of FIG. 16, a jQuery click event is bound to the Clear link within the tool, as shown in box 211. When clicking the link, a javascript function is executed and uses javascript reset to remove content from the form elements and jQuery empty to clear any selected item from the form droppable area as further described in http://www.w3schools.com/jsref/met_form_reset.asp and http://api.jquery.com/empty/. If the user clicks the Clear link inside the information request form panel, as shown in box 212, the information request form is reset back to its default state with no fields filled out, as shown in box 213. If a search result was previously dropped onto the form area, it too is cleared as described above.

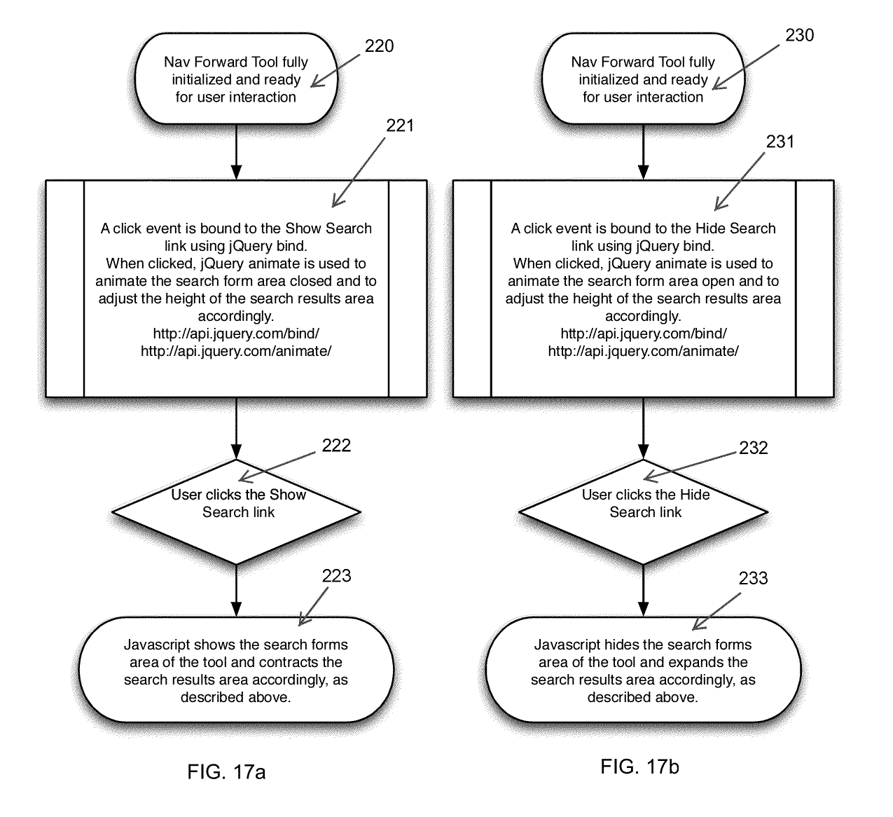

With the fully initialized tool of box 220 of FIG. 17a, a click event is bound to the Show Search link using jQuery bind, as shown in box 221. When clicked, jQuery animate is used to animate the search form area closed and to adjust the height of the search results area accordingly, as shown in box 221 and as further described in http://api.jquery.com/bind/ and http://api.jquery.com/animate/. If the user clicks the Show Search link, as shown in box 222, Javascript shows the search forms area of the tool and contracts the search results area accordingly, as described above and as shown in box 223.

With the fully initialized tool of box 230 of FIG. 17b, a click event is bound to the Hide Search link using jQuery bind, as shown in box 231. When clicked, jQuery animate is used to animate the search form area open and to adjust the height of the search results area accordingly, as shown in box 231 as further described in http://api.jquery.com/bind/ and http://api.jquery.com/animate/. If the user clicks the Hide Search link, as shown in box 232, Javascript hides the search forms area of the tool and contracts the search results area accordingly, as described above and as shown in box 233.

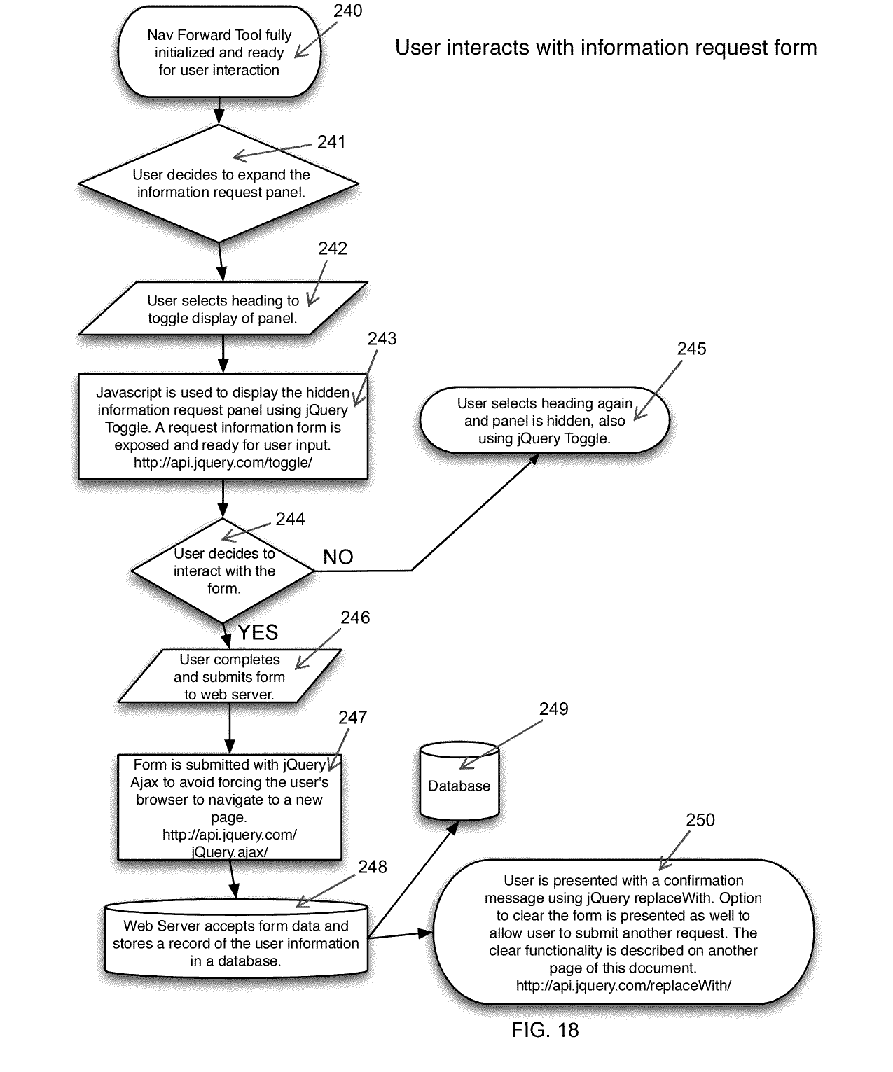

With the fully initialized tool of box 240 of FIG. 18, if the user decides to expand the information request panel, as shown in box 241, the user selects the heading “Request more information” which toggles the display of the panel to display otherwise hidden information, as shown in box 242. Javascript is used to display the hidden information request panel using jQuery Toggle. A request information form is exposed, as shown in FIGS. 1a, 2a, 2b, 3a and 3b, ready for user input as further described in http://api.jquery.com/toggle/. If the user decides not to interact with the form, as shown by choice box 244, the user can select heading again and the request information form is hidden, also using jQuery Toggle, as shown in box 245. If the user decides to interact with the form, the user completes the form and submits it to the web server, as shown in box 246. The request information form is submitted with jQuery Ajax, as shown in box 247, which avoids the user's browser navigating to a new web page as further described in http://api.jquery.com/jQuery.ajax. The web server receives and accepts the data in the request information form and stores a record of the user information in a database, as shown in boxes 248 and 249. The user is then presented with a confirmation message using jQuery replaceWith. The user is also presented with an option to clear the form so the user can submit another information request, say for another vehicle in the search results, as shown in box 250. The clear functionality is described on another page of this document, http://api.jquery.com/replaceWith/.

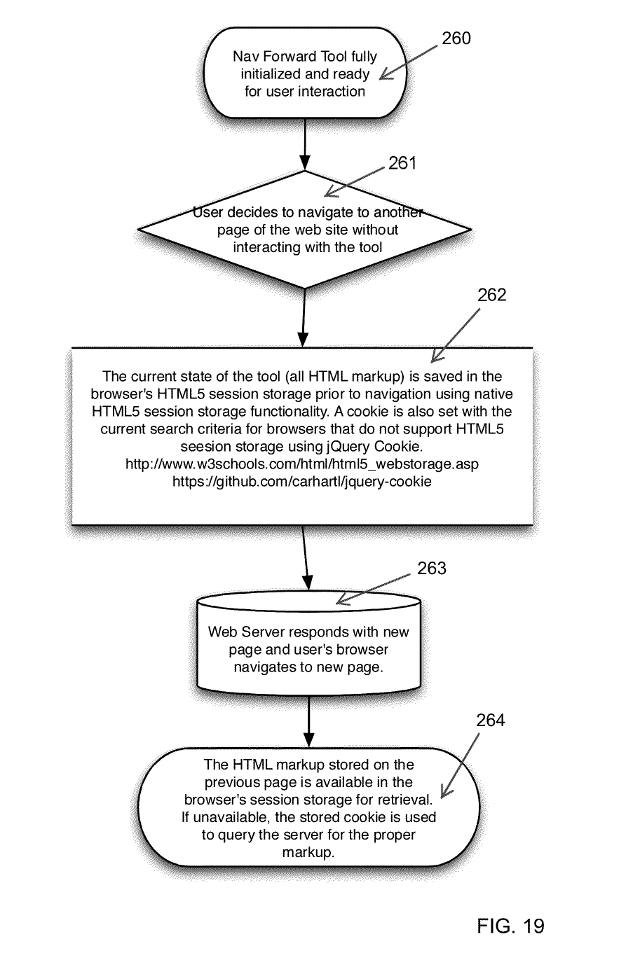

With the fully initialized tool of box 260 of FIG. 19, if the user decides to navigate to another page of the web site without interacting with the tool, as shown in box 261, the current state of the tool, including all the HTML markup, is saved in the browser's HTML5 session storage before navigation away from the current page using native HTML5 session storage functionality, as shown in box 262. A cookie is set with the current search criteria for browsers that do not support HTML5 session storage using the jQuery Cookie plugin, as further described in http://www.w3schools.com/html/html5_webstorage.asp and http://github.com/carhart1/query-cookie. The web server responds with a new page and the user's browser navigates to the new page, as shown in box 263. The HTML markup stored on the previous page is available in the browser's session storage for retrieval, as shown in box 264. If unavailable, the stored cookie is used to query the server for the proper markup.

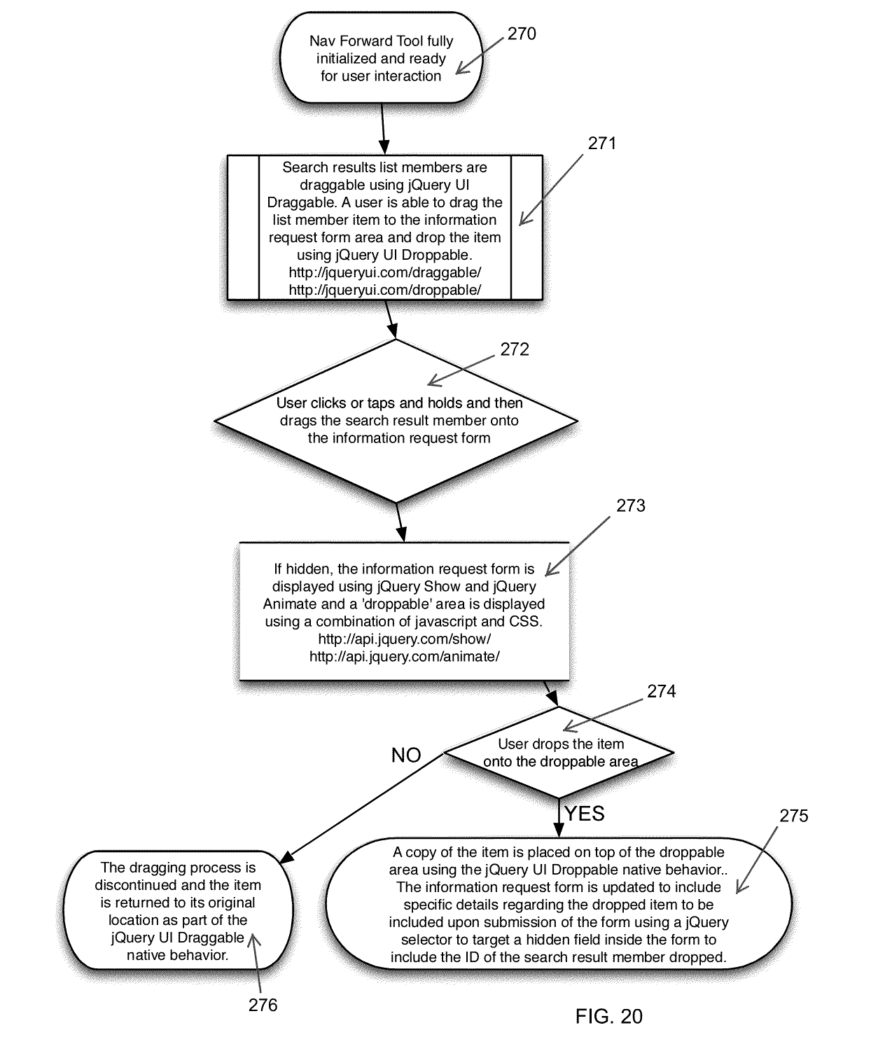

With the fully initialized tool of box 270 of FIG. 20, a user can drag one or more of the search results list member items to the information request form area using jQuery UI Draggable and drop the item using jQuery UI Droppable, as shown in box 271 as further described in http://jqueryui.com/draggable/ and http://jquery.com/droppable/. If the user clicks or taps and holds and then drags the search result member onto the information request form, as shown in box 272, the information request form is displayed, if previously hidden, using jQuery Show and jQuery Animate and a ‘droppable’ area is displayed using a combination of javascript and CSS, as shown in box 273 and as further described in http://api.jquery.com/show/ and http://api.jquery.com/animate/. If the user drops the item onto the droppable area, as shown in box 274, a copy of the item is placed on top of the droppable area using the jQuery UI Droppable native behavior, as shown in box 275. The information request form is updated to include specific details regarding the dropped item to be included upon submission of the form using a jquery selector to target a hidden field inside the form to include the ID of the search result member dropped. If the user aborts dragging of the item in box 274, the dragging process is discontinued and the item is returned to its original location as part of the jQuery UI Draggable native behavior, as shown in box 276.

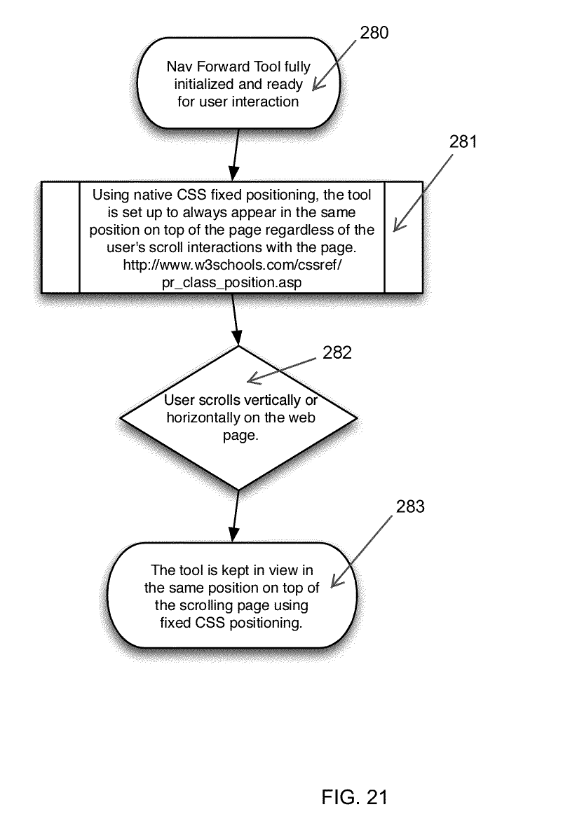

With the fully initialized tool of box 280 of FIG. 21, using native CSS fixed positioning, the tool is set up to always appear in the same position on top of the page regardless of the user's scroll interactions with the page, as shown in box 281 as further described in http://www.w3schools.com/cssref/pr_class_position.asp. If the user scrolls vertically or horizontally on the web page, as shown in box 282, the tool is kept in view in the same position on top of the scrolling page using fixed CSS positioning, as shown in box 283.

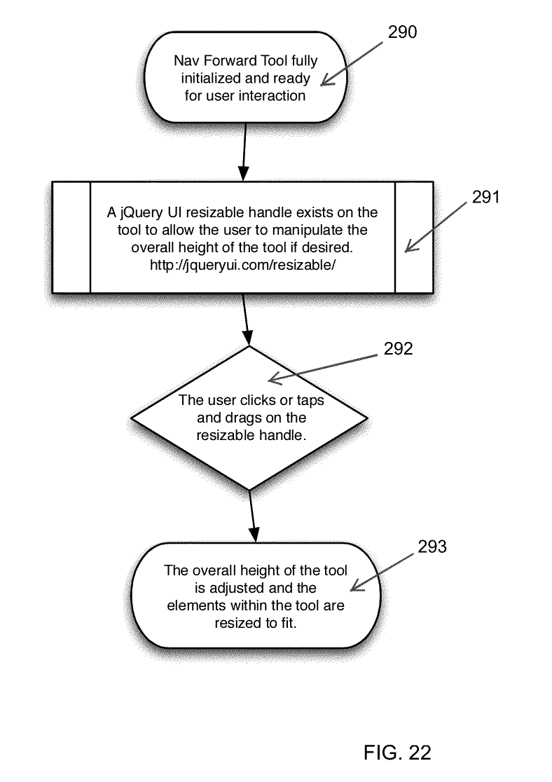

With the fully initialized tool of box 290 of FIG. 22, a jQuery UI resizable handle is provided on the tool to allow the user to manipulate the overall height of the tool if desired, as shown in box 291 as further described in http://jqueryui.com/resizable/. If the user clicks or taps and drags on the resizable handle, as shown in box 292, the overall height of the tool is adjusted and the elements within the tool are resized to fit, as shown in box 293.

While several embodiments, together with modifications thereof, have been described in detail herein and illustrated in the accompanying drawings, it will be evident that various further modifications are possible without departing from the scope of the invention as defined in the appended claims. Nothing in the above specification is intended to limit the invention more narrowly than the appended claims. The examples given are intended only to be illustrative rather than exclusive.

What is claimed is:

1. A method of providing search results to a user on a website, comprising:
a. providing search results wherein said search results include a plurality of members; and
b. selecting a first member of said plurality of members, wherein said selecting causes a web page of said first member to open, wherein said plurality of members remains in view and available for selection on said web page of said first member.

2. The method as recited in claim 1, further comprising selecting a second member of said plurality of members, wherein said selecting causes a web page of said second member to open and replace said web page of said first member, wherein said plurality of members remain available for viewing and selection on said web page of said second member.

3. The method as recited in claim 1, further comprising providing a navigation schematic visible while said web page of said first member is open, wherein said plurality of members are available for viewing and selection in said navigation schematic.

4. The method as recited in claim 3, wherein said navigation schematic remains in view independent of portion of said web page of said first member viewed by the user.

5. The method as recited in claim 3, wherein said navigation schematic includes a user file, further comprising providing for saving said first member in said user file.

6. The method as recited in claim 5, further comprising providing for selecting a second member for viewing and saving in said user file.

7. The method as recited in claim 6, further comprising further comprising comparing said saved first and second members.

8. The method as recited in claim 3, wherein said navigation schematic includes a predefined search filter for adjusting search results.

9. The method as recited in claim 3, wherein said navigation schematic includes a user defined search filter for adjusting search results.

10. The method as recited in claim 3, wherein said navigation schematic includes at least one from the group consisting of a request further information button and a user input tab, further comprising providing that the user can at least one from the group consisting of request further information about said first member and provide user input without leaving said web page of said first member.

11. The method as recited in claim 10, wherein said user input includes user contact information.

12. The method as recited in claim 10, wherein the website is supervised by an entity, wherein said at least one from the group consisting of said request further information and said provide user input is submitted to said entity when the user activates said at least one from the group consisting of said request further information button and said user input tab.

13. The method as recited in claim 10, wherein said request further information includes at least one from the group consisting of requesting a price, an appointment, availability, product details, and product delivery.

14. The method as recited in claim 10, wherein said user input includes at least one from the group consisting of an offer to purchase and a comment.

15. The method as recited in claim 3, further comprising providing jQuery and jQuery UI libraries and using said libraries for keeping said plurality of members in view and available for selection in said navigation schematic.

16. The method as recited in claim 3, further comprising providing HTML5 session storage for storing said navigation schematic.

17. The method as recited in claim 3, further comprising providing facet search and freeform search, further comprising disabling facet search for enabling freeform searching.

18. The method as recited in claim 1, further comprising providing an associated user file, further comprising providing capability of saving said members for comparing in said user file, wherein said compare capability includes comparing said saved members.

19. The method as recited in claim 1, further comprising providing a first Implement functionality to toggle form behavior between two states dependent on user intent. For example, changing how the form submission works based on whether the user is interacting with the freeform search or the faceted search.

20. A method of providing search results to a user on a website, comprising:
a. providing search results on a web page, wherein said search results includes a plurality of members; and
b. providing a user file; and
c. providing a tab on said web page for saving a selected member of said plurality of members in said user file.

21. The method as recited in claim 19, wherein said saving is by dragging and dropping said selected member in said tab.

22. The method as recited in claim 20, wherein said tab is for saving a plurality of selected members in said user file.

23. The method as recited in claim 19, wherein selecting a first member of said plurality of members causes a web page of said first member to open and wherein said plurality of members remain available for selecting for saving on said web page of said first member.

24. The method as recited in claim 22, wherein said plurality of members remain available for selecting in a navigation schematic visible while said web page of said first member is open wherein said user file is available from said navigation schematic.

25. The method as recited in claim 23, wherein said navigation schematic includes said tab, wherein said user file is available from said tab.

26. The method as recited in claim 21, wherein said saving involves dragging a member to said tab in said navigation schematic.

27. A method of providing search results to a user on a website, comprising:
a. providing search results wherein said search results include a plurality of members;
b. selecting a first member, wherein said selecting causes a web page of said first member to open, wherein said plurality of members remains in view and available for selection while viewing said web page of said first member;
c. selecting a second member, wherein said selecting causes a web page of said second member to open, replacing said web page of said first member, wherein said plurality of members remains in view and available for selection while viewing said web page of said second member.

28. A method of providing search results to a user on a website, comprising:
a. providing search results wherein said search results include a plurality of members;
b. selecting a member and viewing the web page for the member; and
c. providing a navigation schematic that provides continued search capability when viewing the page for the selected member.

29. A method of providing search results to a user on a website, comprising:
a. providing search results wherein said search results include a plurality of members; and
b. selecting a first member, wherein said selecting causes a web page of said first member to open, wherein said web page includes capability for at least one from the group consisting of user selection and user input, wherein said plurality of members remains in view and available for selection while viewing said web page of said first member, wherein said plurality of members remains in view and available for selection when the user provides at least one from the group consisting of user selection and user input on said web page of said first member.
